(19) United States
(12) Patent Application Publication
(10) Pub. No.: US 2008/0294547 A1
(43) Pub. Date: Nov. 27, 2008

(54) SYSTEMS AND METHODS FOR ESTABLISHING BUSINESS CREDIT AND IMPROVING PERSONAL CREDIT

(76) Inventor: Jeremy Zigman, Dana Point, CA (US)

Correspondence Address: Matlock Law Group, PC, Suite 200, 1485 Treat Blvd., Walnut Creek, CA, 94597, US

(21) Appl. No.: 12/104,403

(22) Filed: Apr. 16, 2008

Related U.S. Application Data
(60) Provisional application No. 60/939,903, filed on May 24, 2007.

(51) Int. Cl. G06Q 40/00; G06Q 20/00

(52) U.S. Cl. 705/38; 705/35; 705/40

(57) ABSTRACT

Systems and methods are disclosed for establishing one or more personal guarantor(s); establishing one or more business entities; establishing a professional business presence; reporting the professional business presence and the one or more personal guarantors to one or more credit scoring companies; establishing a PAYDEX score of said one or more business entities to a minimum of 80 resulting in an applicant's ability to obtain a larger credit line and at more favorable contract terms determined by one or more credit line providers reviewing external data. Another embodiment includes a method for establishing at least one high credit line credit accounts of one or more business entities with an open trade account of $10,000 or higher maintained in good standing and reporting said trade accounts(s) to the business credit scoring agencies.

### CROSS-REFERENCES TO RELATED APPLICATIONS

This application claims the benefit of U.S. Provisional Application Ser. No. 60/939,903, filed, May, 24 2007, the disclosure of which is incorporated herein by reference in its entirety.

### BACKGROUND

The present invention relates generally to a step-by-step process that a borrower may utilize to establish business credit or improve access to personal credit. In certain aspects, the invention presented herein focuses on systems and methods of obtaining revolving unsecured business credit lines or business credit cards or increased unsecured revolving credit lines.

Real estate investors and business owners often need capital to start, operate, maintain, and/or grow their businesses. There are three types of lending products available to real estate investors and business owners: 1) leases; 2) installment loans; and 3) revolving credit lines. Leases are typically used to enable the person or other legal entities to acquire equipment for a business. Leases are written agreements under which the owner of real or personal property allows another party (sometimes referred to as a “tenant”) to use that property for a specified period of time for a specified amount of consideration. Installment loans are loans that are repaid with a fixed number of periodic, equally-sized payments.

Revolving credit lines are accounts whereby the person or other legal entities (hereinafter “borrowers”) can borrow funds up to a pre-approved limit, repay the balances, and then borrow again as needed, over and over again. Revolving credit lines possess the following characteristics: 1) Do not have a fixed number of payments, 2) Amount of available credit decreases and increases as funds are borrowed and re-paid, 3) Credit may be used repeatedly, 4) Borrower makes payments based only upon the amount borrower actually uses or withdraws, 5) Borrower may re-pay over time (subject to any minimum payment requirements), or in full at any time, generally without pre payment penalties.

With installment loans, lenders approve and distribute funds to the borrowers virtually simultaneously. Therefore, borrowers incur interest from the moment the lender funds the installment loan. Contrary to installment loans, revolving credit lines' approval and distributions of funds do not necessarily occur simultaneously. Borrowers only incur interest when they draw funds from the credit lines.

Real estate investors and business owners alike often find revolving credit lines more preferable than installment loans for two reasons. First, they need money on an ongoing basis, and it would be inconvenient for them to apply for an installment loan each and every time they need to borrow money for their business operations. Since they can draw upon funds as they become available, borrowers essentially qualify for the lines of credit one time and can continually draw upon their funds, so long as they are available at the time they need them, and assuming they do not default under the terms and conditions of each credit line. Second, as previously mentioned, borrowers only incur interest when they draw upon funds from the credit lines so they do not incur interest when they do not need money. Conversely, with an installment loan, borrowers incur interest even when they do not need to draw upon the funds of the loan because interest is assessed when the installment loan is funded.

TWO TYPES OF CREDIT LINES: PERSONAL VS. BUSINESS CREDIT LINES. A “line of credit” is a commonplace term for the amount of money that is available to a person or other legal entity (e.g. corporation, limited liability company, etc.). In many cases it is desirable to have the largest line of credit, or the most funds to be potentially used as a loan, as possible.

To obtain a large line of credit, the person or other legal entity (hereinafter “applicant”) will apply for a credit line with a lender using a credit application. The applicant enters reference information into the credit application regarding financial assets: other credit lines, checking accounts, savings accounts, mutual funds, retirement accounts, real property, and personal property. The lender will review this information and determine whether or not to approve or deny the application and if approved, the amount of credit available to the applicant.

In most cases this information is augmented by looking at the history of the financial asset. For example, the usage of another credit line, the amount of extended credit, and the payment history may be a future indicator on how the applicant will pay back the amount. In instances where the lender believes there is a greater risk associated with the ability of the applicant to repay the line of credit, then the lender will typically increase the interest rate or decline the application altogether. Conversely, if the lender believes there is a less risk associated with the ability of an applicant to repay the line of credit, the lender will typically decrease the interest rate. Usually there is a correlation between the ability of the applicant to repay the credit line, and the lender's decision to approve the application, how much the lender sets the initial credit limit, as well as the interest rate for the credit line.

There are many significant differences between personal and business credit lines/credit cards. Personal credit lines/credit cards are types of credit established in the name and social security number of an applicant. Examples include a credit card or a home equity line of credit (HELOC). Conversely, business credit lines/credit cards are types of credit established in the name and tax identification number (sometimes called an employment identification number or EIN) of a business entity, sometimes requiring a personal guarantee by an applicant such as a business owner or officer.

To obtain personal credit lines or credit cards, applicant borrowers must first qualify under the creditors' lending guidelines. Personal credit line/credit card lending guidelines are generally based upon the credit history and score of the applicant. The three biggest factors that affect an applicant's personal credit score (the major factor for an applicant qualifying for credit) are the ways in which applicants service their debts (e.g., late, prompt, default, etc.), the number of credit inquiries appearing on their credit files, and the amount of debt, particularly unsecured, revolving debt that appears on their credit files.

Each time applicants apply for credit under their own name, the creditor runs a credit inquiry, each of which lowers the applicants' personal credit scores. Assuming applicants qualify for a few credit lines, they will lose the ability to qualify for subsequent credit lines because the inquiries appearing on their credit reports from their initial credit applications will not only lower their credit scores, but will render the applicants ineligible for further credit from lender's viewpoint. Lenders equate more credit extended to applicants and a high number of credit inquiries within a short period of time-usually six months-with higher risk of defaulting (i.e., non-payment).

Applicants' credit scores will also decrease as more unsecured, revolving credit accounts (i.e., credit cards, credit lines) appear on their personal credit files. Assuming they qualify for a few credit lines under their name, each credit issuer will report their account's activity to the credit bureaus (i.e., Experian, Equifax, and Trans Union) after they make a payment. And, once their credit files show that they have multiple credit lines (and balances on those lines), their credit score will diminish significantly which will almost certainly prevent them from qualifying for additional credit lines at subsequent credit banking institutions.

Business credit lines, on the other hand, function differently. A business can enter into contracts, buy and sell real and personal property, as well as apply for and establish its own credit rating. A business's credit file is separate and apart from the credit file of its officers or owners. Many businesses have established credit files and borrow money based upon their respective credit histories. Business credit lines are established in the name of the applicant's business and corresponding employment identification number (EIN), commonly referred to as a tax identification number, not the applicant's name and social security number, and sometimes require a personal guarantee by an applicant such as a business owner or officer.

Unlike personal credit ratings, credit inquiries made on the applicants' businesses do not affect their businesses' credit scores. In addition, the account activity of any credit line for which an applicants' business qualify for will not be reported on their personal credit files. Therefore, applicants will NOT lose their ability to qualify for additional credit lines at subsequent credit banking institutions because their personal credit scores will be unaffected by the number of credit lines their businesses or companies possess or by whatever balances exist on each businesses' credit accounts.

Businesses are expected to borrow capital in order to sustain themselves and grow. On the other hand, individual applicants applying for credit under their own name and social security number have little reason to have a huge amount of unsecured revolving credit. Generally, applicants borrow money for consumer debt to take vacations, remodel their homes, put a child through college, and so forth. Hence, creditors are more likely to grant smaller credit limits to applicants applying for credit under their own names rather than to those applying under their businesses. For example, the person submitting this invention was granted a $2,500 credit limit from Citibank when he applied for credit under his own name as an applicant. After 10 years of having maintained his account in good standing, his credit limit was raised to $10,000. He received an initial credit line of $50,000 from Citibank when he applied for a credit line under his business name and tax identification. Therefore, it is much easier to obtain a larger credit limit when applying as a business rather than as an applicant.

When real estate investors and business owners wish to apply for revolving business credit lines, they can apply for ones that are secured by collateral or unsecured. There are revolving business credit lines that require real, personal or intellectual property to serve as collateral to secure the loan. Requiring such collateral limits many real estate investors and business owners because their borrowing power is limited by the collateral they posses. What are they to do if they have little or even no real, personal or intellectual property? It becomes the proverbial “catch 22.” They need money to make money, and the money they make enables them to buy the assets that can serve as collateral to get the money they need in the first place. Without having the collateral to begin with, they are not able to obtain the revolving credit lines necessary to generate income.

In addition to collateral requirements, many unsecured, revolving, business credit lines require real estate investors and business owners to submit tax returns and financial statements. Often, the information listed on real estate investors' and business owners' tax returns will not meet the qualifications set by the lending institutions issuing said business credit lines.

Therefore, it is extremely beneficial for real estate investors and business owners to apply for credit-score-based, unsecured, revolving business credit lines. Such business credit line applications are ones whose credit worthiness is based upon the information the lenders receive from the credit bureaus.

### SUMMARY OF THE INVENTION

According to one embodiment, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s). In other various aspects, a method of increasing the applicant's aggregate business credit limit is provided, including selecting a non-personally guaranteed cash credit line.

In another embodiment, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities, wherein said one or more business credit lines established is a credit card.

According to another embodiment, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities. Where possible, an aged business entity at least two years old with no liabilities will allow an applicant the best opportunity for establishing a maximum possible amount of unsecured business credit.

According to another embodiment, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, and increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed.

According to another embodiment, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, and increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed; and further comprises increasing the credit score of the one or more personal guarantors through a credit enhancement process; and wherein the credit enhancement process is accomplished in part by selecting one or more of the personal guarantor's personal credit lines and applying for an increase in the credit limit of said credit line; borrowing the maximum amount from the said credit line; and paying off the said personal guarantor's personal revolving credit lines' balance(s) and wherein increasing the credit limit of said personal guarantor's personal credit lines to the maximum allowable amount maximizes the positive impact on the personal guarantors' personal credit rating.

According to another embodiment, a method for-establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed; and further comprises increasing the credit score of the one or more personal guarantors through a credit enhancement process; and wherein the credit enhancement process is accomplished in part by selecting one or more of the personal guarantor's personal credit lines and applying for an increase in the credit limit of said credit line; borrowing the maximum amount from the said credit line; and paying off the said personal guarantor's personal revolving credit lines' balance(s) and wherein increasing the credit limit of said personal guarantor's personal credit lines to the maximum allowable amount maximizes the positive impact on the personal guarantors' personal credit rating, and further comprises disputing all inquiries made by lenders to the credit scoring companies on the personal guarantor's credit report directly associated with business credit line applications until said inquiries are removed.

According to another embodiment, a method for-establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, and increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed; and further comprises increasing the credit score of the one or more personal guarantors through a credit enhancement process; and wherein the credit enhancement process is accomplished in part by selecting one or more of the personal guarantor's personal credit lines and applying for an increase in the credit limit of said credit line; borrowing the maximum amount from the said credit line; and paying off the said personal guarantor's personal revolving credit lines' balance(s) and wherein increasing the credit limit of said personal guarantor's personal credit lines to the maximum allowable amount maximizes the positive impact on the personal guarantors' personal credit rating, and further comprises disputing all inquiries made by lenders to the credit scoring companies on the personal guarantor's credit report directly associated with business credit line applications until said inquiries are removed; wherein said one or more business entities establish one or more new high credit line credit accounts. In certain aspects, the method may variously further comprises adding a high trade line account to the Duns report. In other aspects, the method may variously include increasing said one or more personal guarantors credit score wherein said increased credit score provides a larger credit amount for said one or more business entity unsecured credit lines and wherein the credit limits of said one or more business credit lines are increased in response to an applicant's request.

According to another embodiment, a method for-establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed; and further comprises increasing the credit score of the one or more personal guarantors through a credit enhancement process; and wherein the credit enhancement process is accomplished in part by selecting one or more of the personal guarantor's personal credit lines and applying for an increase in the credit limit of said credit line; borrowing the maximum amount from the said credit line; and paying off the said personal guarantor's personal revolving credit lines' balance(s) and wherein increasing the credit limit of said personal guarantor's personal credit lines to the maximum allowable amount maximizes the positive impact on the personal guarantors' personal, credit rating, and further comprises disputing all inquiries made by lenders to the credit scoring companies on the personal guarantor's credit report directly associated with business credit line applications until said inquiries are removed; wherein said one or more business entities establish one or more new high credit line credit accounts. In certain aspects, the method may variously further comprise adding a high trade line account to the Duns report; wherein said high credit supplier line of credit account is equal to $10,000 or greater of available credit to said one or more business entities.

According to another embodiment, a method for-establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, and increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed; and further comprises increasing the credit score of the one or more personal guarantors through a credit enhancement process; and wherein the credit enhancement process is accomplished in part by selecting one or more of the personal guarantor's personal credit lines and applying for an increase in the credit limit of said credit line; borrowing the maximum amount from the said credit line; and paying off the said personal guarantor's personal revolving credit lines' balance(s) and wherein increasing the credit limit of said personal guarantor's personal credit lines to the maximum allowable amount maximizes the positive impact on the personal guarantors' personal credit rating, and further comprises disputing all inquiries made by lenders to the credit scoring companies on the personal guarantor's credit report directly associated with business credit line applications until said inquiries are removed; wherein said one or more business entities establish one or more new high credit line credit accounts. In certain aspects, the method may variously further comprise adding a high trade line account to the Duns report; wherein said high credit supplier line of credit account is equal to $10,000 or greater of available credit to said one or more business entities; and wherein credit limits of said one or more business credit lines are increased in response to applicant's request. In other various aspects, a method of increasing the applicant's aggregate business credit limit is provided, including selecting a non-personally guaranteed cash credit line.

In certain aspects, a method for establishing the amount of unsecured business credit comprises method steps in any order including establishing one or more personal guarantor(s); establishing one or more business entities; establishing a professional business presence for said one or more business entities; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s); and wherein said establishment of a professional business presence includes obtaining a business license in the city where the one or more business entities office is located, providing said one or more business entity's company's official office address accompanied by said one or more business entity's company listing in the local 411 directory. In other aspects, the business credit line may be a business credit card.

In another embodiment, a method of performing a credit enhancement process comprises method steps in any order including selecting a personal guarantor(s) with an acceptable credit score; selecting a guarantors' personal revolving credit line; applying for an increase in the credit limit of said personal revolving credit line; borrowing the maximum amount from the personal revolving credit line; and paying off said personal revolving credit line, and thereby increasing “high credit” of said personal guarantors' unsecured, revolving credit lines.

In another embodiment, the method of performing a credit enhancement process further comprises method steps in any order variously includes establishing one or more newly opened credit accounts and maintaining said accounts in good standing; establishing one or more newly opened “high credit” account; adding one or more new unsecured credit accounts; and paying down one or more of the personal guarantor's unsecured, revolving credit card balances.

In another embodiment, the method of performing a credit enhancement process further comprises one or more of the following steps in any order including borrowing money from funds invested in one or more certificates of deposit; adding one or more seasoned credit card accounts; and establishing one or more open accounts of trade credit from one or more suppliers. In various aspects; seasoned credit card(s) account are those which primary card holder(s) adds the personal guarantor(s) to one or more of their existing credit card accounts that have been open and in good standing for a period of time to allow for said credit card accounts to appear on the personal guarantor(s) credit report.

In another embodiment, the method of providing credit repair and credit enhancement further comprises performing a credit repair process wherein said process includes one or more disputed items; disputing any derogatory items on the personal guarantor(s) credit report with a credit scoring agency; and disputing any credit inquiries on the personal guarantors' credit report with a credit scoring agency. In certain aspects, said one or more disputed items involve disputing account(s) statuses that are listed as “open” when they are in fact “closed.” In other various aspects, said one or more disputed items involve disputing account(s) that are not the personal guarantor(s)' responsibility. In other aspects, a method of increasing the credit scores of the one or more personal guarantors includes performing a credit repair process wherein said process includes one or more disputed items, disputing any derogatory items on the personal guarantor's credit report with a credit scoring agency, and disputing any unauthorized credit inquiries on the personal guarantor's credit report with a credit scoring agency. In other various aspects the credit enhancement portion includes adding one or more new unsecured credit accounts, paying down one or more of the one or more personal guarantor's credit card balances, borrowing money from funds deposited, borrowing money from funds invested in one or more certificates of deposit, adding one or more seasoned credit card accounts, and establishing one or more open accounts of trade credit from one or more supplies wherein increasing the credit limit of said one or more personal guarantor's credit line to the maximum allowable amount maximizes the positive impact on the one or more personal guarantor's personal credit score and wherein said maximum allowable amount maximizes the number of high credit line of credit accounts available to an applicant.

In another embodiment, a method of establishing one or more high credit line of credit accounts of one or more business entities comprises entering the high credit line of one or more vendors into a credit account management tool; wherein said high credit line of one or more vendors includes an open trade account of $10,000 or higher that are maintained in good standing. In certain aspects, the embodiment may include reporting said trade accounts(s) to the business credit scoring agencies. In other various aspects, a method of establishing one or more high credit line credit accounts of one or more business entities including entering the high credit line of one or more vendors into a credit account management tool wherein the high credit line of one or more vendors includes an open trade account of $10,000 or higher that are maintained in good standing and reporting said trade accounts to the business credit scoring agencies, selecting one or more personal guarantors (PG) to associate with the attainment of said high credit line of credit account management, verifying said one or more PG's credit rating is sufficient to attain said high credit line credit accounts, identifying any derogatory credit items on the one or more personal guarantor's credit report, disputing said derogatory credit items on the one or more personal guarantor's credit report, identifying and disputing any unauthorized credit inquiries on the one or more personal guarantor's credit report, paying one or more credit balances to zero on the one or more personal guarantor's credit report, increasing a maximum credit limit amount of the one or more personal guarantor's revolving credit line accounts, paying off one or more said maximum credit limit amounts of the one or more personal guarantor's revolving credit line accounts to zero on the one or more personal guarantor's credit report, verifying said payoff, verifying the credit score at credit bureaus of said one or more business entities, and obtaining a subsequent increased credit limit amount of the one or more business entities existing business credit line accounts.

In yet another embodiment, a computer-usable medium having computer-readable program code embodied therein for controlling one or more processors; a service provider system wherein said computer system is enabled to access and communicate with remote resources; one or more computer-readable media; and computer-readable instructions on the one or more computer-readable media which, when executed by the one or more processors, cause the one or more processors to perform preprogrammed functions to provide methods for credit repair, credit enhancement and to facilitate methods to automate the establishment of unsecured business credit lines and further services to provide for credit rating improvement services, said program code including instructions for establishing one or more personal guarantor(s); establishing one or more business entities; establishing a professional business presence for said one or more business entities wherein said professional business presence includes obtaining a business license in the city where the business office is located; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s).

In another embodiment, a computer-readable medium for providing data for documents used for credit enhancement services comprises program code for establishing one or more personal guarantor(s); establishing one or more business entities; establishing a professional business presence for said one or more business entities wherein said professional business presence includes obtaining a business license in the city where the business office is located; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities, wherein said one or more business credit lines established is a credit card.

In another embodiment, a method for establishing the amount of unsecured business credit comprises program code for establishing one or more personal guarantor(s); establishing one or more business entities; establishing a professional business presence for said one or more business entities wherein said professional business presence includes obtaining a business license in the city where the business office is located; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities.

In another embodiment, a method for establishing the amount of unsecured business credit comprises program code for establishing one or more personal guarantor(s); establishing one or more business entities; establishing a professional business presence for said one or more business entities wherein said professional business presence includes obtaining a business license in the city where the business office is located; reporting the professional business presence and the one or more personal guarantors to one or more credit scoring companies; establishing a PAYDEX score of said one or more business entities to a minimum of 80 wherein obtaining a PAYDEX score of a minimum of 80 results in an applicant's ability to obtain a larger credit line amounts and wherein said applicant may obtain said credit lines at more favorable contract terms; and applying for and establishing one or more business credit lines wherein said method for establishing the amount of unsecured business credit is determined by one or more credit line providers reviewing external data about one or more personal guarantor(s) and the one or more business entities. In various aspects, the one or more business credit lines may be credit card(s), and wherein establishing said one or more business entities further comprises selecting one or more aged business entities that is at least two years old with no liabilities, and increasing the credit scores of the one or more personal guarantors through a credit repair process; and wherein the credit repair process is accomplished in part by disputing any derogatory items on the personal guarantors' credit report with a credit scoring agency and disputing any credit inquiries on the personal guarantors' credit report with a credit scoring agency until said inquiries are removed.

In another embodiment, a method for increasing a credit applicant's aggregate established business credit lines' credit limits comprising at least one of the following steps in any order, including selecting a non-personally guaranteed cash credit line, selecting a cash credit without a personal guarantor, selecting a non-guaranteed credit line, selecting a personally-guaranteed cash credit line of guaranteed and non-guaranteed cash credit lines, borrowing to the limit of the credit lines established, paying back credit lines with interest, waiting a period of time to request credit limit increases for all established business credit lines and/or obtaining an increase of said credit applicant's aggregate established business credit lines' credit limits.

### BRIEF DESCRIPTION OF DRAWINGS

FIG. 1 shows a credit management spreadsheet checklist tool.

FIG. 2 is an example of a written dispute letter addressed to a creditor.

FIG. 3 is an example of a police report.

FIGS. 4A, 4B, 4C, 4D are drawings of a sample ID Theft Affidavit that is used to dispute and remove credit inquiries from the personal guarantor's (PG) personal credit report.

FIG. 5 shows an exemplary method to report credit vendor accounts to business credit reporting agencies.

FIG. 6A is a replication of a Dun & Bradstreet search page.

FIG. 6B is a replication of a Dun & Bradstreet search results page.

FIG. 7 is an example of how to perform a search for potential suppliers.

FIG. 8 is a block diagram showing a method of providing personal guaranteed suppliers sufficient to establish a PAYDEX score.

FIG. 9A is an exemplary method of utilizing a Payment Reference Form to maximize the number of high credit supplier accounts.

FIG. 9B is an exemplary Dun & Bradstreet Payment Reference Form.

FIG. 10 shows an exemplary Credit Score Based Application.

FIG. 11 is a block diagram showing the relationship between the Applicant, the guarantor(s), the business entity(s), and the line of credit offeror(s).

FIG. 12 is a block diagram showing the relationship between business entity, the entity (s) offering the line of credit (lenders), the credit bureaus, and the vendors of the business.

FIG. 13 is a flowchart showing the selection of an aged business,entity and improving its business credit score as well as the selection and improvement of the credit score of the personal guarantor.

FIG. 14 is a flowchart showing the process of increasing the Applicant's aggregate business credit lines' credit limits.

FIG. 15 is a flowchart showing the process of selecting the personal guarantor as well as improving the credit score of a personal guarantor.

FIG. 16 is an example of a sample dispute letter detailed process highlighting the key components of the letter and how they are used in the and credit repair process.

FIG. 17 is a flowchart showing the process of credit enhancement.

FIGS. 18A-18B are flow diagrams describing aspects of methods for accessing personal and business credit lines.

FIG. 19 is a flow diagram describing Entity-related Credit Application methods.

FIG. 20 is a flow diagram describing Credit Account-related Disputable Items methods.

FIG. 21 is a flow diagram describing Credit Account-related Collections Items methods.

FIG. 22 shows a block diagram illustrating components of an exemplary operating environment.

FIG. 23 illustrates an exemplary computer system, in which various embodiments of the present invention may be implemented.

FIG. 24 is a flowchart showing the process of increasing the Applicant's aggregate business credit lines' credit limits through personally guaranteed and non-personally guaranteed cash credit lines, cash credit without a personal guarantor or a non-guaranteed credit line.

### DETAILED DESCRIPTION

The following narrative describes the process for establishing credit-score-based, unsecured, revolving business credit lines. The applicant (a.k.a. ‘natural person’) who follows the process described in this patent application is hereinafter referred to as the “Applicant.” Furthermore, the Applicant and the personal guarantor may be the same natural person, or may be two different people. And, the Applicant and the personal guarantor are referred to in the masculine gender for grammatical consistency. The words “personal guarantor” and “guarantor” are used interchangeably and are synonymous.

PERSONAL GUARANTOR—Before beginning the credit building process, the Applicant needs to identify who will personally guarantee the business credit lines. The choices are as follows: the Applicant, someone the Applicant knows, or someone the Applicant does not know. All things being equal, it is easier if the Applicant can personally guaranty the credit lines so that he does not have to work with another party. However, if the Applicant's credit history is so poor (and his credit rating is beyond some repair), then he will have to find someone else to personally guarantee the credit lines.

How does the Applicant decide if he should serve as the personal guarantor or if he needs to find someone else to serve in that capacity? Referring to Table 1, the “rule of thumb” is as follows: A guarantor can be anyone whose credit score is initially 650 or greater and who has no more than one derogatory item on his credit report. Derogatory items are any items that negatively impact a consumer's credit score such as late payments, charge-offs, collection accounts, bankruptcy filings, judgments, settlements, or foreclosures, etc.

If the Applicant has one or two derogatory items on his credit report, he should dispute them. If the dispute results in the removal of some or all of the derogatory items, the Applicant will be in a position to personally guarantee the credit lines for which he applies under his business if he has no more than one derogatory item after removal of some or all of the disputed items. If the Applicant has several derogatory items, then he should find someone else to serve as the guarantor. At the same time, he can begin to dispute items on his credit report so that he will be in a position to personally guarantee credit lines in the future.

TABLE 1

| Applicant's Situation | Guarantor |
|---|---|
| Applicant has no derogatory items, but does not have a | Applicant |
| credit score of 750+ | |
| Applicant has one or two derogatory items | Applicant |
| Applicant has no derogatory items, but does not have a | Applicant |
| substantive enough credit history | |
| Applicant has multiple (more than two) derogatory items | Someone else |

In addition to selecting a guarantor, the Applicant also needs to decide how much credit he is seeking to establish because obtaining $200,000 to $1 million requires a guarantor with a stronger credit rating than is necessary for obtaining $50,000 to $100,000. The Applicant can obtain $50,000 to $100,000 in 30 to 45 days, while $200,000 to $1 million can take 3 to 6 months. The initial steps required to obtain $50,000 to $100,000 are the same as for obtaining $200,000 to $1 million, except for the fact that there are additional steps required for $200,000 to $1 million. So the Applicant can begin with modest goals and modify them as it becomes necessary for him, or he can go for the gusto from the start.

CREDIT LINES OF $50,000 TO $100,000. The Applicant can establish $50,000 to $ 100,000 of business credit relatively easily by completing a few simple steps. The ideal guarantor's credit report should contain the following information: 1) No derogatory items, 2) Credit score of 680 or better, 3) Substantial enough credit history, 4) As few recent credit inquiries as possible (ideally none).

When establishing $50,000 to $100,000 in business credit, the Applicant will mainly be applying for business credit cards as it is easier to qualify for them than it is to qualify for business credit lines. Credit card applications are scrutinized less than credit line applications. Typically, business credit card limits are set between $10,000 and $25,000 per card. To amass $50,000 of business cards, the Applicant needs to get between 2 and 5 approvals.

Substantial Enough Credit History. A substantial credit history refers to the number of accounts listed on a guarantor's credit report and the length of time each account has been established. There is no precise number of accounts or length of credit history that can be given as a “measuring stick” that will determine exactly what the Applicant or his guarantor needs in order to qualify as having a “substantial credit history.” It is necessary to use common sense when evaluating the credit history of a potential guarantor. Typically, a sufficient credit history would include a few credit cards, a car payment, mortgage, and possibly even a student loan. The more accounts established with significant history—five years or greater—the stronger one's credit profile.

Credit Inquiries. The impact of credit inquiries is easy to understand. Each time a creditor views the guarantor's credit report, a credit inquiry is placed on his credit report and each credit inquiry lowers the guarantor's credit score. With each inquiry that appears on his credit report comes the possibility of another credit account that the guarantor will be responsible for re-paying. As more credit accounts appear on the guarantor's credit report, his odds of defaulting increase as he has more debts to service. In addition, having a large number of credit inquiries in a condensed period of time gives the impression to a bank underwriter that the guarantor is submitting credit applications to various creditors because he is desperate for money and, therefore, in a financial crisis. Lenders do not want to loan money to someone who may be in a financial crisis because the odds of default rise significantly. Hence the reasoning behind the credit bureaus' scoring systems lowering the guarantor's credit score each time a creditor pulls his credit report. Although each inquiry only lowers his credit score slightly, numerous credit inquiries can add up to a significant lowering of his score.

For this reason, it is essential to dispute and eliminate as many inquiries as possible from the guarantor's credit report.

CREDIT LINES OF $200,000 to $1 million PLUS. When establishing between $200,000 and $1 million or more of business credit lines, the ideal guarantor's credit report should contain the following information: 1) No derogatory items, 2) Credit Score of 750 or better, 3) Substantial enough credit history, 4) Credit card “high credit” of at least $30,000, 5) Little to no current credit card balances, 6) As few recent credit inquiries as possible (ideally none).

If the Applicant does not meet the requirements listed above, he has two choices: 1) raise his credit score to improve his credit history (items 3-6); or, 2) find someone whose credit score and history meet the requirements listed above (or are close enough that he can repair and/or enhance the other person's credit rating to meet said requirements). Generally speaking, it is fairly easy to modify some items on the credit report to meet requirements 2 through 6 (above) if requirement 1 is met.

When establishing $200,000 to $1 million in business credit, the Applicant will mainly be applying for business credit lines (as opposed to credit cards). Many of the same elements necessary to establish $50,000 to $100,000 in business credit cards are necessary to establish $200,000 to $1 million in business credit lines. There are additional elements to establish in order to qualify for $200,000 and $1 million, that once met, will enable the Applicant to obtain additional credit lines with higher limits per account; the Applicant can amass additional credit lines of approximately $200,000 every 45 days with an average limit of $30,000 to $50,000 per line.

High Credit. A bank underwriter is going to look closely at the “high credit” on any and all of the guarantor's credit cards. A credit card's “credit limit” and “high credit” are different. The credit limit is the highest a credit card balance can reach before the bank will decline any future charges. High credit, by contrast, is the most the credit balance has actually reached. For example, John Smith has a credit card that has a $10,000 limit. The highest balance John Smith's card has ever reached is $5,000. The credit limit in this example is $10,000 with the high credit of $5,000. An underwriter will look at the high credit, not the credit limit.

Why is the guarantor's credit card's high credit so important? When an underwriter is evaluating whether or not to approve a $50,000 unsecured business credit line, the underwriter is looking for the personal guarantor's history servicing a similar type of loan product. Since the revolving business credit lines the Applicant is applying for are unsecured, the underwriter will base his decision in large part upon the actual performance of unsecured debt that the guarantor has successfully serviced. The fact that a guarantor may have a mortgage for $100,000 or more on his credit report does not influence an underwriter much because a mortgage loan, by definition, is collateralized, or secured, by real property. A credit card, on the other hand, is not collateralized and is, therefore, unsecured as well as revolving. Ideally, the Applicant wants the guarantor to have a high credit of $30,000 or greater of unsecured credit in order to obtain a $50,000 credit line approval.

Credit Card Balances. This next section focuses on raising the guarantor's credit score to over 750 as well as focuses on issues pertaining to unsecured personal credit card debt. While having low credit card balances are helpful for obtaining $50,000 to $100,000 business credit lines, they are especially critical for obtaining $200,000 to $1 million business credit lines. As previously mentioned, even though the Applicant wants the guarantor's high credit to be as high as possible, he wants the credit card balances to be as low as possible, preferably at zero, before submitting each business credit line application. The high credit refers to the amount that the credit card has reached in the past, while the current balance refers to the balance of the account as of today. For example, a guarantor has a credit card with a current balance of $0, but with a high credit of $35,000. In the past, a guarantor maxed out his limit of $35,000. He subsequently paid off the balance to zero, making his high credit on that particular credit card $35,000, and the current balance is $0.

If the Applicant does not have the means to pay off the guarantor's-personal credit card balances, the guarantor should apply for a couple of business credit cards before he applies for business credit lines. He does not apply for the business credit cards, however, until after he has established a Dun & Bradstreet report for his company (discussed later). As previously mentioned, business credit card applications are more easily approved with less lender scrutiny than business credit lines. The number of business credit cards that the guarantor will initially need to apply for will vary depending upon how much in credit card balances he needs to pay down. Each business credit card application should be approved with a credit limit between $10,000 and $20,000, so two to three applications should be sufficient for most guarantors.

Once approved, the guarantor pays off his personal credit card balances by transferring the balances on the guarantor's personal credit cards on to the guarantor's business credit cards. Since business credit card accounts are not reported to the personal credit bureaus, these balances will not appear on the guarantor's personal credit and, consequently, will not affect his score.

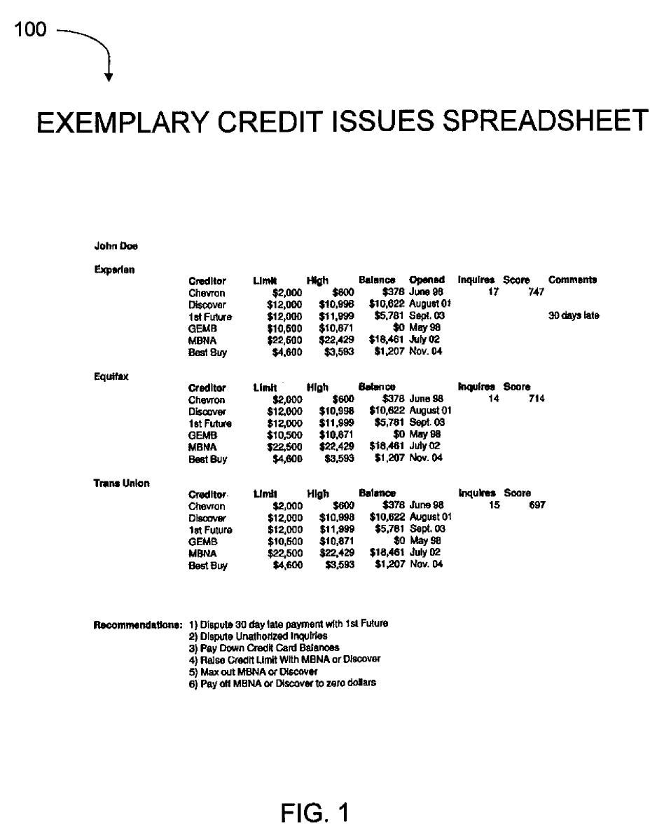

Referring to FIG. 1, no matter how good the guarantor's credit score is, in most cases, the Applicant will need to improve the guarantor's credit report somewhat. The Applicant will need to have credit inquiries removed, pay down credit card balances, and increase the high credit of the guarantor. Once the Applicant identifies who the guarantor will be, he should use a spreadsheet to easily identify the items on the guarantor's credit report that need improving.

CREDIT REPORT/CREDIT YOUR IMPROVEMENT. The information contained in this section is designed to provide the Applicant with techniques to improve the guarantor's credit score. These techniques can be applied to whomever the Applicant decides will personally guarantee the credit lines, whether it is the Applicant himself or someone else.

Factors That Lower Credit Scores. Derogatory information such as late payments, charge-offs, judgments, evictions, foreclosures, and bankruptcies, etc. negatively affect the guarantor's credit score more than anything else.

The second factor that will negatively impact the guarantor's credit score is the amount of unsecured revolving debt (i.e., credit cards) that appears on his credit report. Once the guarantor's credit card balances reach 50% of his limits, his credit score will drop significantly. For example, if his credit card limit is $10,000 and the balance is $5,000, then his credit score will drop significantly. The closer the balance gets towards $ 10,000, the greater his credit score will diminish.

Another factor that will negatively impact the guarantor's credit score is credit inquiries. According to section 604 of the Fair Credit Reporting Act (FCRA), a creditor must have a guarantor's authorization in order to pull his credit file.

Often, a guarantor's name and personal information appear on several marketing lists. The companies that own the marketing lists circulate the guarantor's information to other marketing companies, who in turn sell that information to lenders. These lenders pull the guarantor's credit file, thereby creating credit inquiries without his authorization. The sum total of all of the inquiries lowers the guarantor's credit score significantly.

In addition to the preceding factors that negatively impact the guarantor's credit score, closed accounts whose status is listed as open, as well as accounts that do not belong to the guarantor, will adversely affect his credit score.

Sometimes family members' account information can appear on the guarantor's credit report, particularly if the guarantor bears a similar name to theirs. For example, John Smith's account information could appear on John Smith, II, John Smith, Jr., John Smith, Sr., and so on.

Disputing a Derogatory Item with Creditors. Now that the factors that can negatively impact the guarantor's credit score have been explained, techniques for how to raise said credit score will be provided.

Disputing derogatory items such as a 30-, 60-, 90-, or 120-day late notices or charge-offs, etc. directly with creditors are easily accomplished by contacting the creditor. The guarantor calls the creditor and requests the creditor to fax him a letter requesting that the credit bureaus remove the derogatory reporting(s) from his credit report.

Often creditors send form letters that are signed “customer service” or are printed with an employee's name but no signature. The letter must be written on bank letterhead and must bear a printed name accompanied by a signature of a company employee in order for the credit bureaus to authenticate the letter. Once the guarantor receives a copy of the letter in the proper format, the Applicant and/or the guarantor forwards a copy of that letter to each of the three credit bureaus. The credit bureaus will normally delete the derogatory item from the guarantor's credit report within one to four weeks from their receipt of the letter.

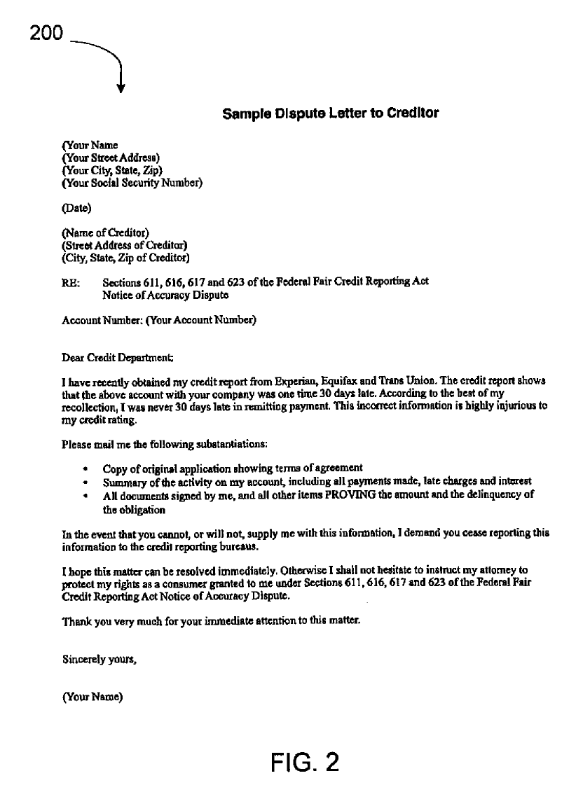

Referring to FIG. 2, if the guarantor is not able to get a supervisor to fax or mail him a letter, he sends the creditor a written dispute demanding that the creditor provide him with proof of the derogatory item or instruct the credit bureaus to delete the derogatory item from the guarantor's credit report. The dispute letter instructs the creditor to prove the accuracy of the derogatory reporting(s) or delete the derogatory item(s) from the credit report.

The Fair Credit Reporting Act (FCRA) puts the onus on the creditor to prove the accuracy of any item reported on a credit file within 30 days or order its removal from the credit report. Over time, many banks have merged with one another or have sold many of their loans to other banks. These mergers and portfolio sales have made it difficult for banks to verify the accuracy of the derogatory items within 30 days allotted by the FCRA because paperwork and documents are archived or are in the possession of the previous the loan holder.

The Applicant and/or the guarantor may find that the creditors respond to the dispute letters acknowledging receipt of them and stating that their reporting is accurate. However, in most cases, they do not provide the proof requested in the guarantor's dispute letter. The guarantor replies to the creditors' responses and insists that they provide the requisite proof. In most cases, creditors will eventually send the guarantor a letter stating that they have instructed the credit bureaus to remove the disputed item(s). If the creditors will not remove the disputed item from the guarantor's credit report and refuse to provide him with requisite proof, he might want to consider suing the creditor. He should contact an attorney for legal advice on this matter.

Disputing Bankruptcies, Foreclosures, and Judgments. Bankruptcies, foreclosures, and judgments need to be disputed differently than late payments. Credit bureaus index or classify credit files by guarantor's first name, last name, address, and social security number. How does the credit bureau's computer system know to which credit file it should list a bankruptcy, foreclosure, or judgment item for someone who has a common name such as John Smith? A bankruptcy filing and foreclosure notice lists the name and address of the filer, not the social security number. The bureau's computer system picks up a foreclosure notice with the name “John Smith” and the address listed on the filing. Since the computer system has a credit file for John Smith bearing the same address listed on the foreclosure filing, the computer system connects the filing to John Smith thus adding a foreclosure filing to John Smith's credit report.

What happens if the bureau's computer system mistakenly places the foreclosure notice on the credit file of another person also named John Smith? The mistaken John Smith can dispute the accuracy of the reporting if the address on the foreclosure notice does not match his address listed on his credit report. Consequently, the bureau will remove the foreclosure notice from the other John Smith's credit report.

The FCRA puts the burden of proof on creditors and credit bureaus to prove the accuracy of any reporting. Why not make it difficult for the credit bureaus to prove the accuracy of a public item such as a bankruptcy, foreclosure, or judgment? To do so, perform the following measures: Remove the address listed on the bankruptcy, foreclosure, or judgment notice from the guarantor's credit file.

If the guarantor currently resides at the same address listed on the bankruptcy or foreclosure filing, he will need to call every creditor to provide them with his new address; his statements will then be sent to that new address. Perhaps he can use a friend or relative's address. If he cannot use a friend or relative's address, find a business that offers mail service (not a post office box or “PMB”). The new address should be in a different city than the current one listed or on the guarantor's credit report.

Once the guarantor has changed the address with his current creditors, he needs to contact the credit bureaus to provide his new address. Once his new address has been updated on his credit report, he should remove the address (the address that is listed on his bankruptcy, foreclosure, or judgment filing). In all likelihood, the credit bureaus will remove the address (the one listed on the bankruptcy filing) from his credit file. He needs to wait until he gets confirmation that the credit bureaus have deleted said address from his credit file. If he does not change the address with his current creditors, then those creditors will report his address along with the rest of his account information at the end of the next billing cycle. By changing his address with the creditors, the creditors will report his new address to the credit bureaus.

Once the guarantor receives confirmation from the credit bureaus that the old address has been deleted from his file, he needs to dispute the bankruptcy, foreclosure, or judgment filing with each credit bureau. If the credit bureau is unable to match his name to the address listed on the bankruptcy, foreclosure, or judgment filing, then the chances are high that they will not be able to verify the accuracy of the filing. And if they cannot verify the accuracy of the filing, they will have to remove the filing from his credit file.

Disputing Collection Items. A collection item appears when a borrower or guarantor does not pay an account. The creditor then assigns that account to a collection company. In addition to collection attempts, the collection company reports that item to the credit bureaus. Collection companies often offer the borrower the option of paying a reduced amount to settle the debt. Once the borrower pays the agreed upon settlement amount, the collection company updates the credit report to show the collection as paid. A paid collection item does improve the guarantor's credit score slightly. However, the guarantor's credit report will show that he had a collection account at some previous point in time. Any history of a collection item will significantly reduce the guarantor's credit score and diminish its capacity to increase in the future.

If the guarantor has an unpaid collection item, he can contact the collection company to make a settlement. They will often settle for a far less amount than the original amount of the debt, especially the older the collection item is. For example, a collection item that is five years old can usually be settled for 10% of the amount owed. On the other hand, a collection item that is only six months old is more likely to be settled for 75% of the amount owed. The more an item ages, the less collectable it becomes.

Regardless of how old the collection is, the guarantor can always make his first offer at 10% of the amount owed. Normally, the collection agent will gyrate in disgust and disbelief. The agent will counter-offer; usually much higher than 10%. The guarantor continues countering until he settles on an amount that he can afford. It is suggested that he start his negotiations at 10% of the total debt owed in the hopes of settling somewhere around 30%.

Once a settlement amount is agreed upon, the guarantor is to inform the collection agent that he wants the collection company and the original creditor to remove any and all derogatory reporting on the account from his credit report in exchange for his paying the agreed settlement amount.

The guarantor memorializes the settlement and its terms in writing prior to paying the collection company any sum of money. Once the guarantor gets the agreement signed and in writing, he is to pay the collection company the agreed amount and have the collection company fax him the letter instructing the credit bureaus to delete the derogatory item.

In most instances, the collection company is collecting on behalf of the creditor that is owed the money. If the collection company does not own the debt, the company will have to seek approval from the creditor. If the creditor is a credit card company, then chances are that there are two derogatory items reported for the same account: the first being from the credit card company (i.e., a 30-, 60-, 90-, or 120-day late payment and a charge-off); and the second being from the collection company. The agreement should state that any and all derogatory reports (from the credit card company and the collection company) are to be deleted from the guarantor's credit report in exchange for payment.

Removing Unauthorized Credit Inquiries. In order to remove unauthorized credit inquiries, the guarantor submits a package to the credit bureaus consisting of an affidavit, a police report, and a cover letter to the credit bureaus. The Federal Trade Commission (FTC) Fraud Affidavit can be obtained by visiting http://www.ftc.gov/bcp/edu/microsites/idtheft.

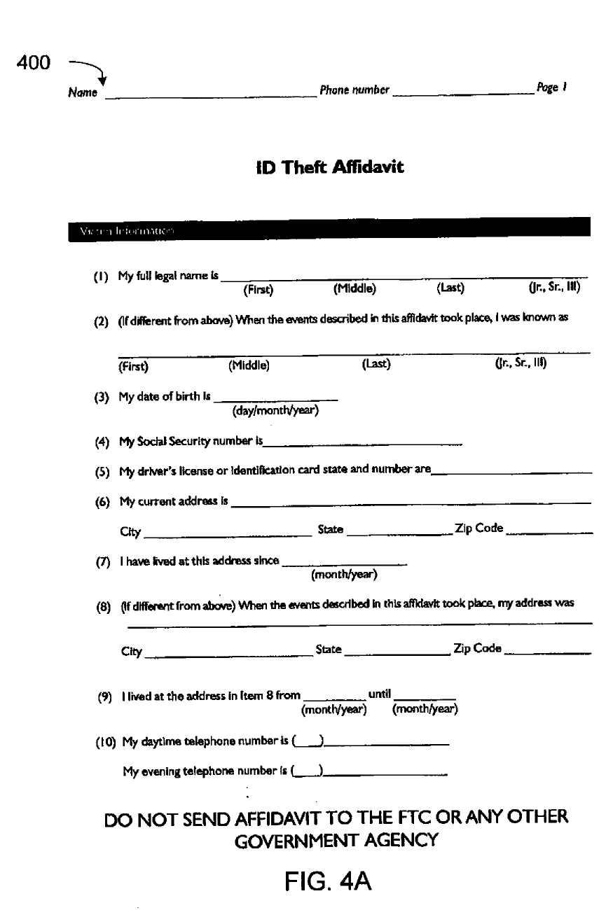

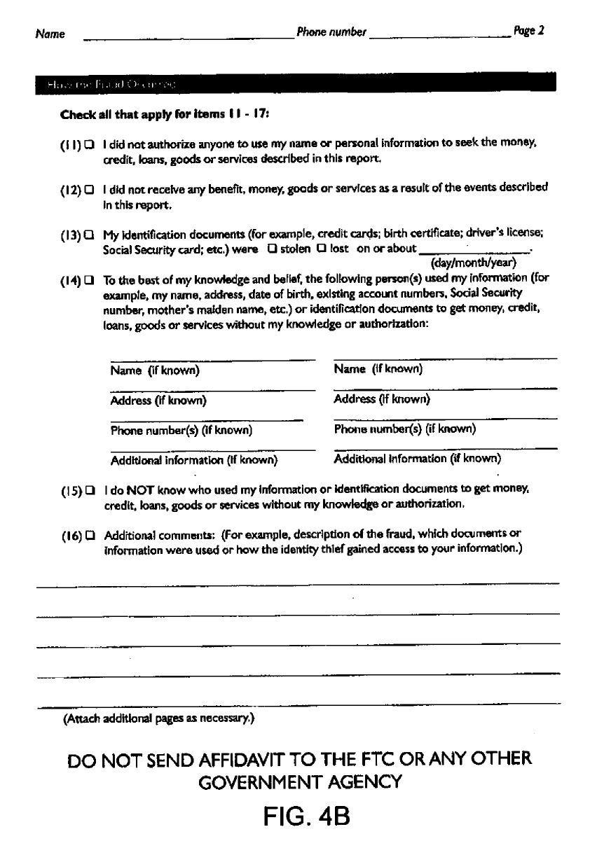

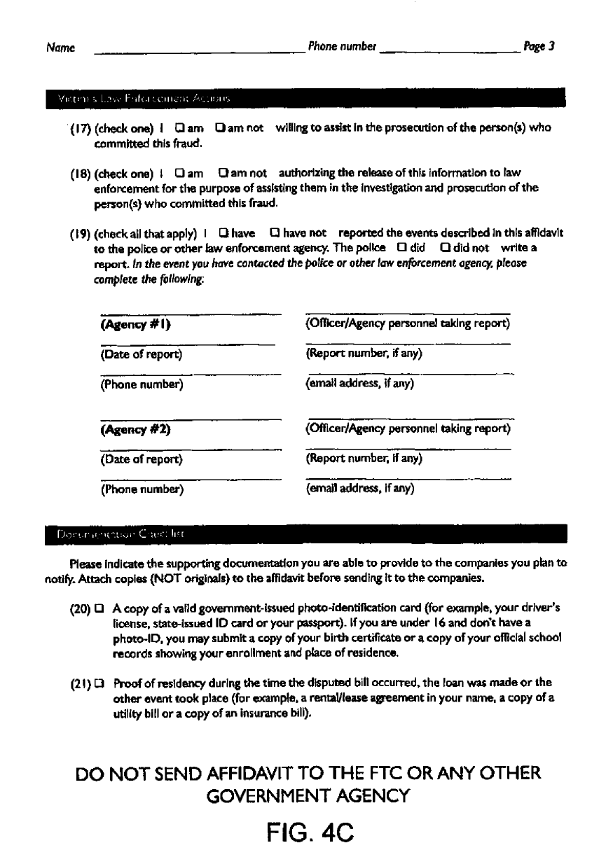

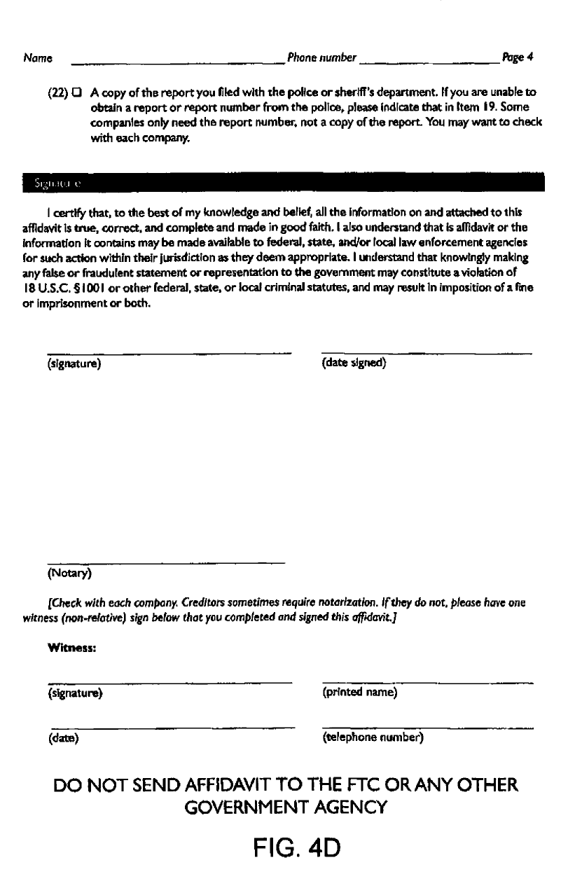

According to FIG. 4A, 4B, 4C and 4D, an ID Theft Affidavit is prepared if unauthorized inquiries are a result of such activity. The guarantor files a police report noting all of his unauthorized inquiries.

Dispute with the Credit Bureaus. In addition to disputing derogatory items with the creditors, the guarantor disputes the items with the credit bureaus as well. He begins by contacting the credit bureaus with which the inaccuracies appear. Sometimes inaccuracies may appear on only one bureau's report, while the others may appear on all three. Contact the bureau(s) to verbally dispute the inaccuracy of the item(s) in question.

In addition to verbally disputing the item(s), the guarantor needs to send a dispute letter to the bureau(s) to document his dispute(s). The bureau(s) will place the item(s) in dispute and will contact the creditor(s), who have 30 days within which to verify the accuracy or inaccuracy of the item(s) disputed. If the creditor is unable to verify the accuracy of the disputed item, it will instruct the credit bureau(s) to remove the derogatory reporting. If the creditor does not respond within 30 days, then the bureau(s) will remove the disputed item.

Review of disputing a derogatory item:
The guarantor attempts to resolve his disputes with the creditor by calling the creditor and requesting that a supervisor fax him a letter for easier and quicker updating of the credit report.
The guarantor notes for his records the supervisor's/representative's name and employee I.D. number (if available) along with the date and time of the call.
If the guarantor cannot get a supervisor to fax him a letter within a few days, he sends and faxes a written dispute letter.
If the guarantor does not receive a response stating that the creditor will remove the negative item, he re-disputes the item with the creditor and reiterates his demand for proof of accuracy of the derogatory item. This step should be repeated until the guarantor gets the response he desires.
Once the guarantor receives a letter from the creditor stating that the derogatory item will be removed, he forwards the letter, along with a cover letter, to each of the three credit bureaus.

CREDIT ENHANCEMENT. Credit enhancement differs from credit repair in that credit repair refers to the process of disputing and removing items that negatively impact your credit score. Credit enhancement refers to the process of adding items or accounts that favorably impact your credit score.

How to Add High Credit Amounts to a Credit Report. If the guarantor does not have a credit card account with a high balance close to $30,000, then he has three possible solutions. The first solution is for him to find someone he knows who has a credit card with a credit limit of $30,000 or close to it (say, $20,000-$25,000). This person adds him to their account as a joint responsible cardholder or an authorized user. An authorized user means he has been issued a card but has no financial responsibility for repayment. A joint responsible cardholder means that he is jointly responsible for making the payments for that account.

The card bearing his name will be sent to the primary cardholder so he will never have the opportunity to make charges on the primary cardholder's account. The month after he is added to the account as a joint responsible cardholder or an authorized user, the credit card company will report the entire account history on his credit report. The reporting will make no mention of the fact that he was just added as a joint responsible account holder or an authorized user the month before. For example, John Smith has a credit card that opened in 1993. Both the high credit and credit limit are $35,000 with the current balance at $0. John Smith adds the guarantor as a joint responsible account holder March 1. One month later (i.e., April 1), the guarantor's credit report will list the account on his credit report as follows:
Credit Limit: $35,000
High Credit: $35,000
Current Balance: $0
Date Opened: 1993
Account Status: Current

NOTE: It is important that the account that the account the guarantor is added to as a joint responsible cardholder or an authorized user is in good standing. If that account has a late payment or any sort of previously reported derogatory item(s), said item(s) will be reported on the guarantor's credit file too.

This technique is a “double-edged sword” in the sense that whatever account information is reported on the primary cardholder's credit report will also be reported on the guarantor's credit report. The guarantor needs to check the primary cardholder's credit report first to verify that the account history has no derogatory reports on it before being added to that account. Secondly, the guarantor must trust that the primary account holder will not be late while the guarantor is a jointly responsible cardholder or an authorized user. Lastly, if the primary account holder has a balance on his card (even if the payments have all been prompt), the guarantor's credit report will show an account with a high ratio of credit available to credit used. As previously mentioned, the guarantor's credit score will drop once the balance exceeds 50% of the credit limit.

The second solution for adding high credit amounts to a credit report is to have the guarantor request a credit limit increase from one of his existing credit cards. Once his limit is increased, he should max out his credit card so that his high credit will be equal to his new credit limit. He can max out his card by using a convenience check or having the credit card company wire money into his checking account.

Most credit card issuers charge a fee for a convenience check or wire. Most of the fees are capped at a maximum amount. For example, some charge 3% of the transferred amount with a $5 minimum and a $75 maximum. If there is no limit to the fee, then the guarantor should consider using a different card or be prepared to pay that fee as a “cost of doing business.” The guarantor can check with his credit card issuer for their fees on such transactions because not only do they vary among card companies, but also existing fees are always subject to change. Once he knows the fees, he must weigh his options accordingly.

When the guarantor maxes out his card about one week before his statement closes, he avoids paying a full month's worth of interest. His credit card company will update his new balance with the credit bureaus within a few days of the closing of his next statement. Once his credit report is updated to reflect the maxed out balance of his credit card, he pays back the amount he maxed out and waits for his next statement to close. Within a few days of the next statement's closing date, the credit card company will report his account's balance to the credit bureaus, only this time the update will reflect a $0 balance.

The third solution for adding high credit amounts to a credit report is to contact various vendors who will add a guarantor to an account holder's credit card account with a high balance of up to $30,000 for a small fee. The Applicant and/or guarantor can contact the submitter of this patent application for such vendors.

Adding Other Accounts to Your Credit File. Trade Capital is a company that will finance deposits. This means that their company makes guarantors a loan secured by the proceeds, which are then deposited in the guarantor's name at a bank, savings & loan or credit union of their choosing. This allows the guarantor to establish or improve his company's or his personal credit rating all the while improving his balance sheet in one easy transaction without credit underwriting.

Simply put, Trade Capital will report his loan payments on his personal and/or business credit reports. Since they finance the deposit of the loan, there is no limit as to the loan amount. For example, suppose the guarantor wants a $100,000 loan to appear on his credit report. Trade Capital will then deposit $100,000 into a bank account bearing his name. The money deposited into the account is used as collateral to secure a $100,000 loan. The guarantor simply pays monthly interest payments on the $100,000 (or whatever amount you wish to borrow).

Trade Capital will create as many loans as the guarantor wishes. All he has to do is make the monthly interest payments. In addition to reporting to the credit bureaus, the money that is loaned to him is sitting in a bank account bearing his name. This amount can be used to verify his bank balance as well as provide seasoned funds. Visit www.try.tc for details on this program.

Another way to improve the guarantor's credit score is to create a bank reference by depositing money into a certificate of deposit (CD), and then borrow money against the amount deposited in the CD. The loan is fully collateralized by the amount deposited into the CD so the guarantor will have little difficulty getting a bank to issue him a loan. For example, assume that the guarantor deposits $20,000 into a CD. He then borrows $20,000 from the bank, using the CD as collateral. The term of his loan will mirror that of the CD. He makes minimum monthly payments on the loan and when the CD matures, he pays off his loan. Even though the interest rate of his loan will be greater than the yield of the CD, the bank will report to the credit bureaus that he paid promptly on a $20,000 loan. Such a reporting will go a long way toward establishing a strong credit history.

The guarantor can employ this technique at multiple banks simultaneously which will result in having multiple accounts with prompt reporting added to his credit report within a couple of months. An example of how he could apply this technique is as follows. He funds a CD at Bank A for $1,000. He borrows $1,000 using the CD as collateral. He takes the $1,000 he receives from the loan at Bank A and opens up a CD at Bank B. He borrows $1,000 from Bank B using the CD as collateral. He takes the $1,000 he receives from the loan at Bank B to open up a CD at Bank C. He can repeat this process as many times as he wishes. The more instances he repeats it, the more prompt accounts will be added to his credit history.

Paying Down Card Balances. The guarantor pays each credit card off in full so that he has a $0 balance. If he is short on funds to pay off his credit card balances, he can ask people he knows and who trust him to loan him the money necessary to pay off his credit card balances in full. If the amount he needs to pay his cards in full is more than one person can loan him, he will have to ask several people. The idea is for the guarantor to raise sufficient capital to pay off his balances in full. For example, if a guarantor owes $20,000 in credit debt, he could ask four people to loan him $5,000 for a short period of time. Those that loan the guarantor money can also loan the guarantor money from funds they have available on any of their credit cards.

When the guarantor's credit score increases to 750 (assuming he has no other derogatory item[s]), he can apply for $200,000 in business credit lines and pay back those who loaned him the money to pay off his credit card(s). Since business credit balances do not appear on the guarantor's personal credit report, his personal credit score will not decrease when he pays back those who loaned him the money.

If the guarantor lacks sufficient funds to pay off his credit card balances and he does not know anyone who will loan him the money to pay them off, then he needs to apply for some business credit cards before applying for business credit lines. As previously mentioned business credit cards and credit lines are established in the name and tax identification number of the business and are not reported on the guarantor's personal credit report. The guarantor obtains enough of a credit limit on one or more business credit cards to pay off any balances on his personal credit cards. The amount of business credit cards he will need to apply for will depend on the amount of personal credit card debt that he needs to pay off.

Before the guarantor applies for business credit cards, he wants to put himself in the best possible position to get approved. He should therefore, remove any and all credit inquiries prior to applying for the business cards. The guarantor should not have any derogatory items on his credit report.

In addition to removing credit inquiries and making sure that the guarantor has no derogatory items listed on his credit report, the Applicant (could be one and the same as the guarantor) may establish his business credit report with Dun and Bradstreet, including obtaining an 80 PAYDEX score.

Updating Credit Card Balances with The Credit Bureaus. Once the guarantor's credit cards are paid off, he contacts his credit card company to request a “zero balance” letter. The letter must be written on bank letterhead and must bear an employee's printed name and signature. Once the credit bureaus receive the letter, his balances will update on his credit report within one to four weeks.

By following the aforementioned steps, the guarantor will be approved for some business credit cards. He will use the business credit cards to pay off his personal credit cards by way of a balance transfer. Once the personal credit cards are paid off, his personal credit score will increase significantly, and he will be in a position to apply for several business credit lines at $50,000 per line.

Updating Account Status. To correct any accounts that are listed as “open” when they are closed, or to correct any accounts that are listed on the guarantor's credit report that do not belong to him, he follows the same procedures for disputing derogatory information previously mentioned. Instead of disputing the accuracy of a derogatory item, he disputes the status of the account.

FINDING SOMEONE TO BE A PERSONAL GUARANTOR. There are several ways for the Applicant to find someone to be his personal guarantor.

Prospecting. The first thing the Applicant needs to do is to identify whom he will prospect. He can prospect people he knows or people he does not presently know. People he knows can include friends, relatives, and/or acquaintances. One or more of them may have good credit and may be willing to be his personal guarantor. If he is a part of a community organization such as a church, rotary club, or the like, he can put up a notice on their bulletin board or if he can place some type of notice in their organization's newsletter.

The Applicant can also prospect people whom he does not know. He finds potential interested people by attending real estate investment clubs (sometimes referred to as real estate investing associations [REIA]) the local area.

Networking. In addition to prospecting for a personal guarantor at a local REIA, the Applicant can search for potential guarantors by networking with people in the real estate industry such as escrow officers, real estate agents or mortgage brokers. Yet another way to prospect for potential guarantors is from advertisements placed by the Applicant on online real estate bulletin boards or newspapers.

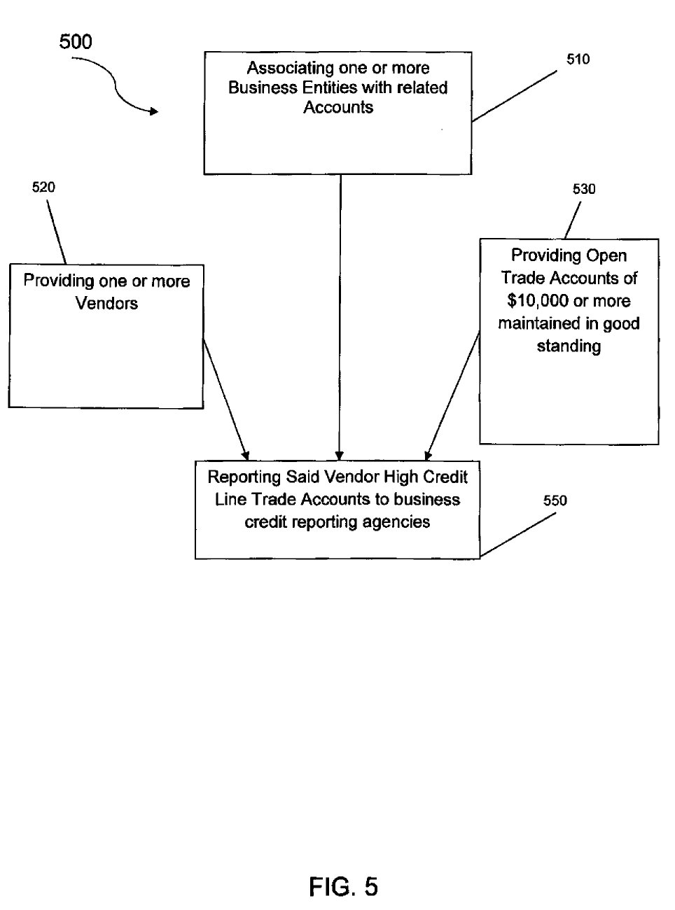

BUSINESS HISTORY. In addition to choosing the personal guarantor, the Applicant needs to address his company's business history. New businesses stand a greater likelihood to default on a loan as compared to businesses with a history. All things being equal, the longer the Applicant's business history, the more comfortable banks will be in granting credit. Banks will generally grant a smaller credit limit to Applicants whose business is a start-up rather than whose business has at least a two-year business history. FIG. 5 shows an exemplary method to identify what items on a guarantor's credit report need improving and what items represent potential existing high credit accounts. FIG. 5 illustrates a method of establishing one or more high credit line credit accounts of one or more business entities 500. The Applicant begins by associating one or more Business Entities with related accounts 510, wherein one or more vendors are provided 520 with open trade accounts of $10,000 or more 530. The open trade accounts are maintained in good standing 530. The Applicant then reports these high credit line accounts to business credit scoring agencies 550. In the various aspects, the method may provide ID of items on a guarantor's credit report which need improving and what items represent potential existing high credit accounts. This figure shows an exemplary method to report high credit vendor accounts to business credit reporting agencies.

If an Applicant has a business that is at least two years old, he establishes a credit history for his existing business, assuming his business does not have an existing business credit file with any derogatory items on it. If he does not have an operating business, then he has two choices: 1) create a new business entity; and, 2) build credit to that entity or purchase an “aged business entity” to which to build credit.

Regardless of whether the Applicant establishes a credit history with a new business or with an aged business entity, the Applicant has to decide the type of business structure to utilize. His choices are a limited liability company (LLC), corporation, limited partnership, or a sole proprietorship.

Corporations, limited liability companies, and limited partnerships are established by filing the appropriate paperwork at the Secretary of State's office in which the Applicant plans to operate his business.

Sole proprietorships are created when applicants file a document with their local municipality legally entitling them to conduct business under a business name. For example, applicants wishing to operate as sole proprietors in California do so by filing what is called a “Fictitious Business Statement” at their local County Recorder's Office. Applicants need to contact their local municipality (County Recorder, city licensing office, etc.) to find out what document needs to be filed in order to operate as a sole proprietor.

By way of illustration, John Smith has a carpet-cleaning business and files a Fictitious Business Statement stating that John Smith is “doing business as” (DBA) Quality Carpet Cleaning. Quality Carpet Cleaning is not a separate legal business entity such as a corporation or LLC; it is merely a filing stating John Smith is conducting business under an assumed or fictitious name.

The Applicant can build credit lines with larger credit limits to an “aged business entity” more so than he can to a start-up company. An “aged business” is an entity which has previously been filed. Upon its filing, an entity is issued a file number, which is akin to the “birth date” of that entity. The Applicant uses the filing date as the company's start date.

The Applicant lists the original filing date of the aged business entity as the date the business began its operations on any business credit applications. Banks check the credit history of one of the current owners or officers of the business who will serve as the personal guarantor. Business owners can change over time. The personal guarantor need not be the same person who originally filed the aged business entity.

The Applicant selects an aged business by first finding the name of one. Said entity can be in the form of a sole proprietorship, corporation, limited liability company (LLC) or limited partnership. The Applicant includes the personal guarantor he selects (either himself or another natural person) to the business by adding him as an officer of the company and stating as such on any credit application submitted. In doing so, the Applicant “marries” an aged business entity with a personal guarantor that meets the banks approval guidelines.

To find an aged business entity, the Applicant visits the website of his local Secretary of State's office, County Recorder, or appropriate government agency where business entities are filed. Once the Applicant finds the name of an aged business entity, he needs to verify that it is clear of any debts or liabilities. He searches the database of the two most used business credit bureaus—Dun & Bradstreet and Experian—to determine if either bureau has a credit file for the business entity being considered for selection. If a judgment or other public filing exists, the chances of Dun & Bradstreet or Experian having a record of it are pretty high. If the aged entity he is considering selecting does not have a Dun & Bradstreet or an Experian credit file, then the odds of any debt, lien, or liability existing are quite small.

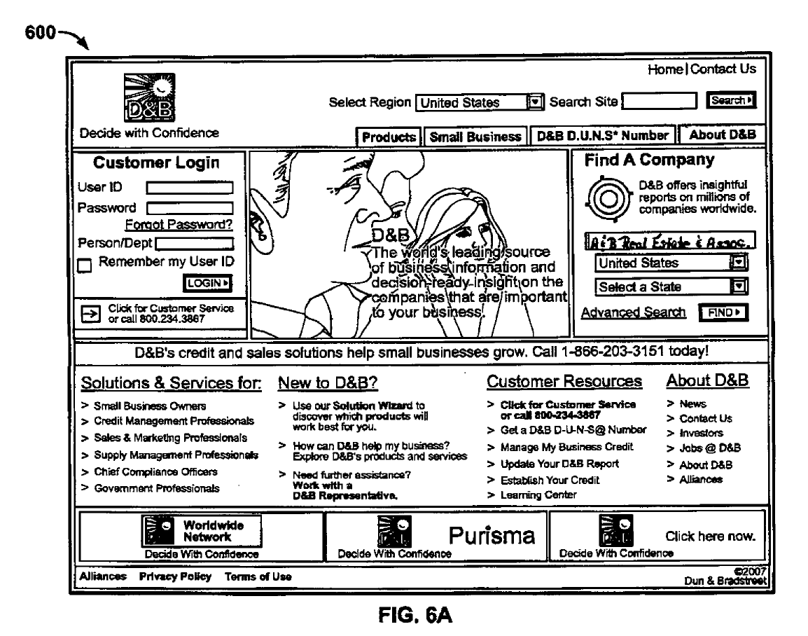

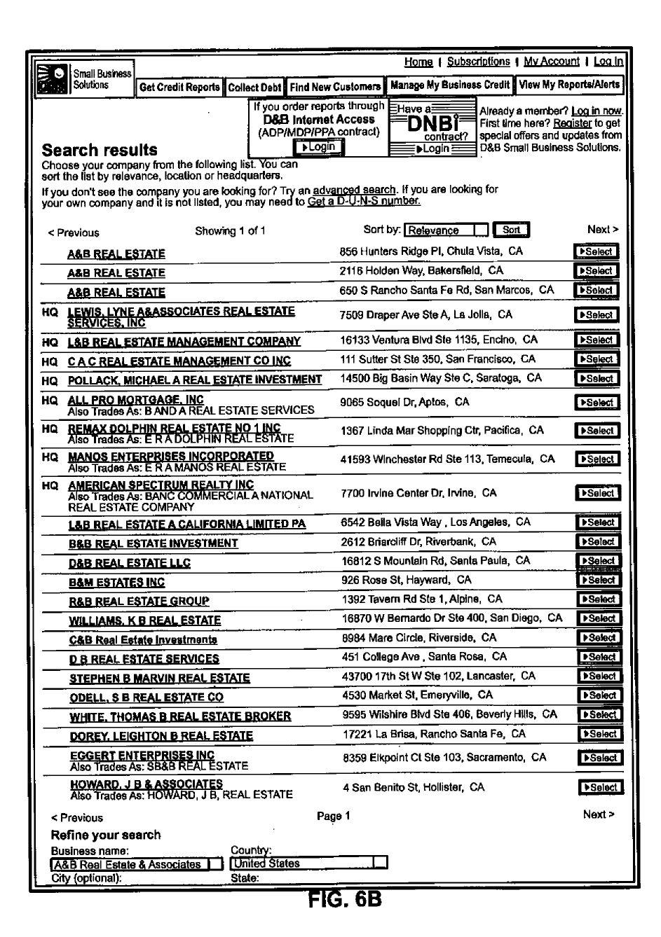

Referring to FIG. 6, to search the database of Dun & Bradstreet, one would visit www.dnb.com. On the right side of the page 600, the Applicant types in the name of the aged business entity and state where it was filed under “Find A Company.”

If the Applicant does not see the name of the aged business entity appear on the search results at Dun and Bradstreet, then he performs the same search at Experian's website at www.smartbusinessreports.com. If the Applicant sees the exact name of the aged business entity appear as a result of a business search at either Dun and Bradstreet's or Experian's respective websites, then the Applicant searches for other possible aged business entities to use. Where possible, an aged business entity at least two years old with no liabilities will allow an applicant the best opportunity for establishing a maximum possible amount of unsecured business credit.

Once the Applicant finds an aged business entity, he contacts the person who originally filed it and offers to buy the name of the entity from that person. If possible, the Applicant offers the applicant a small monthly salary of $200 to hold an officer position, such as vice-president.

To find the original filer, the Applicant searches free online databases such as www.anywho.com or other similar websites. If the Applicant is unable to find the person from the free sites, he contacts a skip-tracing service.

By following the procedures listed above, the Applicant purchases an aged business entity that can be documented by the original filing number.

Dun & Bradstreet. When the Applicant's company submits its credit applications, the banks will order the Applicant's business' credit file from Dun & Bradstreet. The banks rely heavily on the information listed on his company's Duns report in order to decide whether or not to approve his company's application, and if approved, the credit limit to be granted.

Professional Business Presence. Before the Applicant builds his company's Dun and Bradstreet credit report, he has to establish a professional business presence. This consists of his company's official office address accompanied by his company's listing in the 411 directory.

If the Applicant currently has an office, he publishes his company's street address, city, state, zip code, and phone number in the 41 1 directory as Dun and Bradstreet will verify all of this information. If he presently works from his home, he obtains a professional office address by utilizing an executive office address. An executive office is a commercial office location that gives you a prime business address at which to receive mail. The Applicant can find executive offices in his local area by searching using a exemplary search tool such as Google® and entering a search term such as “executive offices” or “virtual offices” plus the name of his city.

In order to tie in the Applicant's phone number to his executive office address, he orders a business “remote call forwarding” phone number, which is also known as a “virtual” phone number. This type of phone number is a one that is issued by the business department of the local phone company without having to install a jack at his location. The phone number is created internally in the phone company's computer system and “forwarded” or “pointed” to a phone number of his choosing such as his home or cell phone. When someone calls the remote call forwarding number, the phone rings to the number to which it is pointed.

The key is to have the phone company list his company's phone number and executive office address (including the street address, city, state, and zip code) in the 411 directory. It is important that the phone number to which his business phone is pointed has a professional voice mail message attached to it.

Sometimes, a bank will approve the Applicant's company for a business credit line subject to a banker performing a “site visit.” A site visit consists of a banker visiting the Applicant's office to verify its location. The banker comes into the Applicant's office; they briefly exchange pleasantries and the banker leaves. A day office is a very inexpensive way to handle site visits.

Once the Applicant has established his company's professional business presence, he is ready to establish and build his company's business credit report with Dun and Bradstreet. His company's report begins as a “marketing file” that contains no independently verifiable information on his company other than the information he supplies to Dun & Bradstreet. His company's report becomes “complete” when it is assigned a PAYDEX score and when Dun & Bradstreet verifies the company's professional business presence.

The Coveted PAYDEX Score. Dun & Bradstreet provides the Applicant's company a PAYDEX score based upon how his company pays its bills to its suppliers or vendors. When a certain number of vendors (usually four) supply Dun & Bradstreet their payment experiences with his company, Dun & Bradstreet creates a PAYDEX score for his company. When all vendors (usually four) report a prompt payment, his company's PAYDEX score will be 80. Lenders like to see a PAYDEX score of 80. The Applicant's goal, therefore, is to create a complete Dun & Bradstreet report for his company with a PAYDEX score of 80. He can create a complete report through Dun & Bradstreet's Credit Builder Service.

The Applicant creates a complete Duns file with an 80 PAYDEX score by ordering the Credit Builder service from Dun & Bradstreet. Upon ordering the Credit Builder service, Dun & Bradstreet will create a Duns number for the Applicant's company. Dun & Bradstreet will also build his company's credit file to include pertinent information such as his company's start date, officers, owner(s), business location, sales figures, and PAYDEX score. When providing his company's start date, he gives the original file date of the aged business entity. If the incorrect start date is listed on the report, he calls Dun & Bradstreet to have the correct date updated on the report.

Selecting Suppliers. Dun & Bradstreet will only allow the Applicant. to submit a certain type of vendor when he orders their Credit Builder service. Dun & Bradstreet will not allow him to submit trade-tape suppliers (as previously discussed) in connection with the Credit Builder Service because trade-tape suppliers report account-holder information automatically. Trade-tape suppliers are large companies that report financial activity on each account holder to Dun & Bradstreet automatically via trade-tape. Examples of trade-tape suppliers include Staples, Home Depot, FedEx Kinko's, Office Max, etc.

The suppliers the Applicant furnishes need to be smaller companies who do not have a trade-tape relationship established such as his attorney, accountant, computer service company, cleaning service, contractors, or other suppliers from whom he orders supplies or services. However, some of these smaller suppliers may only have a “marketing file,” meaning Dun & Bradstreet lacks sufficient information on them to consider the companies reliable enough to serve as a reference.

The Applicant cannot use a trade-tape supplier and cannot use a company only having a marketing file. He can, however, submit non-trade-tape suppliers that have a complete file with Dun & Bradstreet. The Applicant verifies if his non-trade-tape suppliers have a complete file by calling Dun and Bradstreet.

If the Applicant lacks sufficient suppliers for a PAYDEX score after thoroughly reviewing his records, he searches the yellow pages to create a list of potential suppliers or vendors. He checks to see which of those suppliers has a full or complete Duns file. He contacts those vendors that have a complete Duns file asking them if they will provide Dun & Bradstreet with a payment reference for his company if he orders products or services from them and pays the invoices promptly. Examples of vendors the Applicant can search include print shops, maid services, computer services, etc. The point of this exercise is for the Applicant to establish accounts with local suppliers who have a full Duns file and who can provide references about how his company pays its bill to each of them.

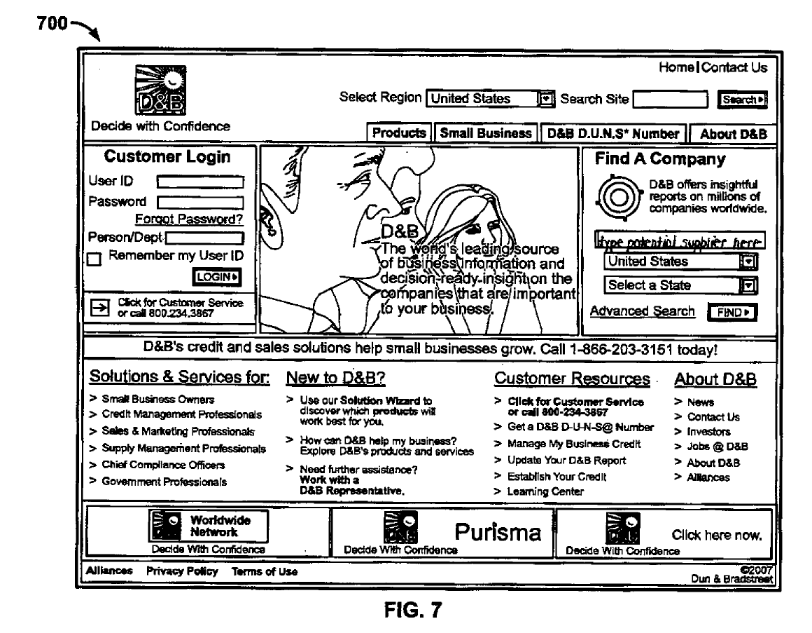

Referring to FIG. 7, prior to contacting a potential supplier for a reference, the Applicant firsts verifies that the supplier has a complete Duns file with Dun & Bradstreet 700. He performs a preliminary search by performing an advanced search on their website—www.dnb.com. He searches by company phone number; not by company name. If the result of the search by phone number reveals the name and address of his prospective supplier, then at least he will know that the vendor has some sort of Duns report; he will not, however, know if the report is a complete file or just a marketing file.

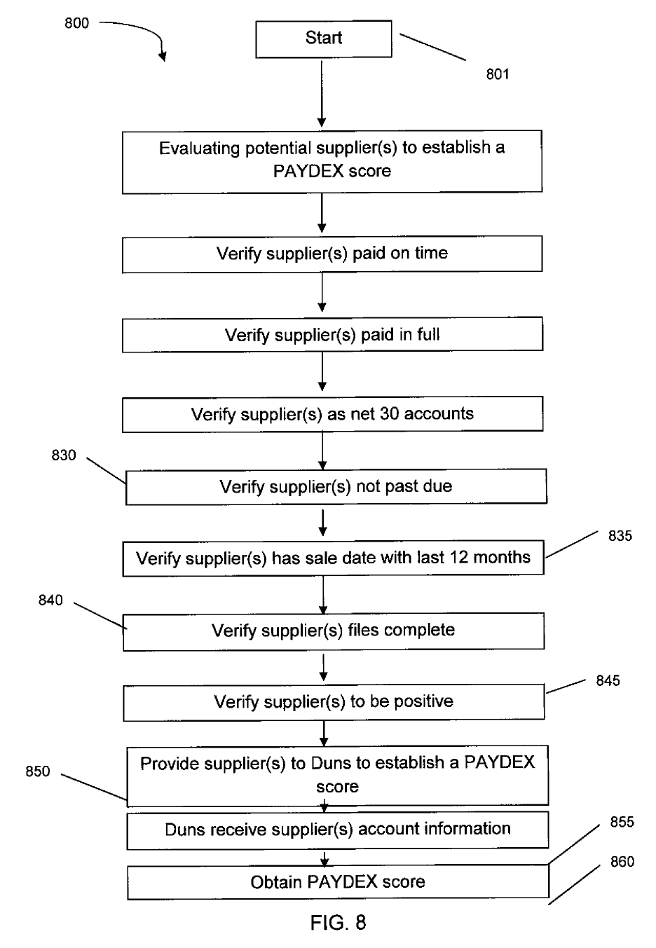

A method of providing a sufficient number of suppliers to establish a PAYDEX score 800 is shown in FIG. 8. The applicant verifies that the supplier has paid on time 815 before the applicant has provided a sufficient number of suppliers to D&B to evaluate a PAYDEX score 810, assuming all other D&B requirements are met. Once the applicant has found a sufficient number of suppliers 810 that have complete files to establish a PAYDEX score, he verifies that suppliers have paid in full 820, that they have as net 30 accounts 825, that the suppliers are not past due 830 and that there is a sale date within the last 12 months 835. After verifying that the suppliers file are complete 840 and the suppliers are positive 845, they are provided to Duns to establish a PAYDEX score 850 and Duns receives their account information 855. Then, the one or more business entities obtains a PAYDEX score 860.

A Duns representative will contact each of the Applicant's submitted vendors within a few days of ordering the Credit Builder Service by phone or fax to receive the account info between the applicant and supplier. The representative will ask each of his vendors for the following information: 1) high credit, 2) current amount owed, 3) past due amount (if applicable), 4) payment terms, 5) payment history (late or prompt), 6) name of contact person at the vendor, and 7) phone number.

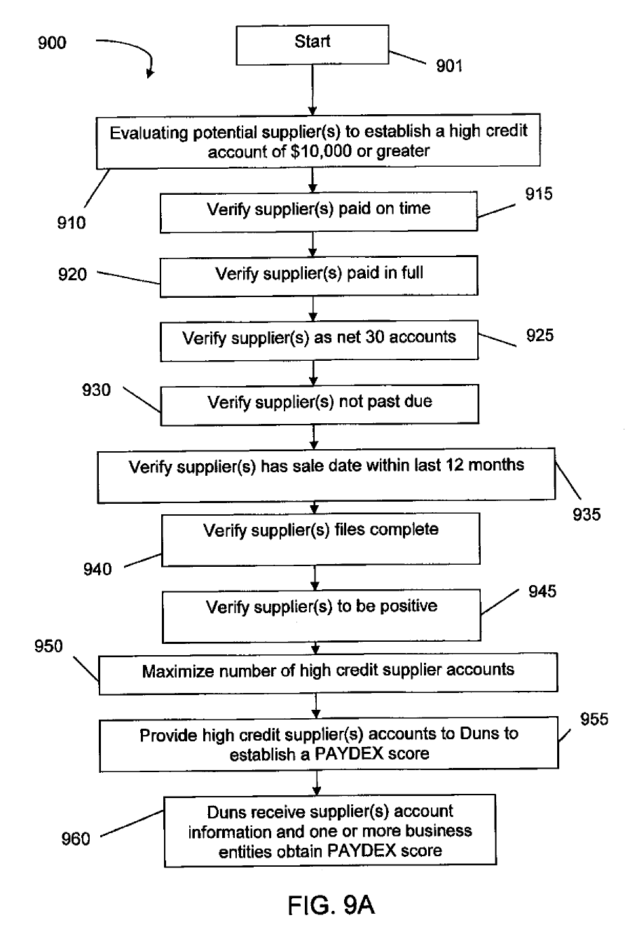

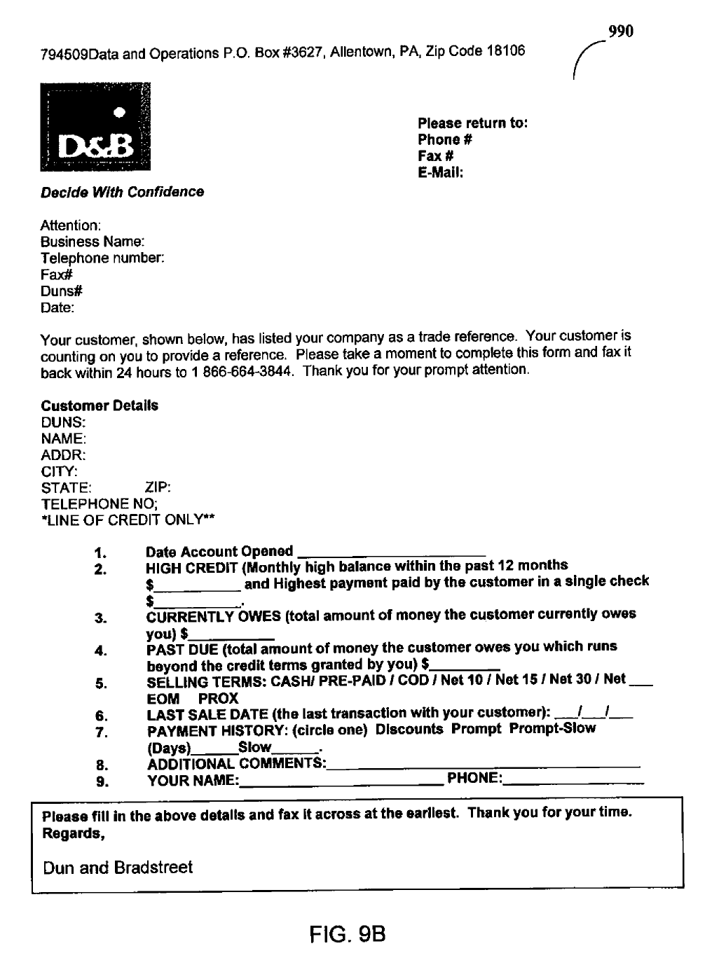

Referring to FIG. 9A, a method 900 for establishing one or more high credit supplier accounts and providing one or more high credit supplier accounts information to Duns is shown. In certain aspects, Duns may request that a “Dun & Bradstreet Payment Reference Form” 990, FIG. 9B. High credit refers to the total amount of credit extended or, in some cases, the credit limit set. The current amount owed is obvious; as is past due amount. Payment terms refer to the amount of time the customer has to pay the bill from the date of invoice. Payment history refers to how the Applicant's company pays its bills—prompt or late. The Applicant's goal is to have each vendor report nothing currently owed, which means the Applicant must pay his invoice in full prior to submitting his vendors to Dun & Bradstreet. In addition, he wants his vendors to report “N/A” (not applicable) for past due amount, “Net 30” for payment terms, and “prompt” for payment history. The applicant will enter the high credit supplier process 901, by referring to a hard copy checklist in a solution binder and materials or by selecting a high credit supplier management form and template in various aspects of computer implemented embodiments. Either way, the applicant will begin the process 901 by requesting to establish one or more high credit supplier accounts 910. To determine that the supplier qualifies as a high credit supplier account, the applicant will verify whether the credit line of the high credit supplier account is $10,000 or greater 910. Next, the applicant will verify the supplier has paid on time 915 and also that all high credit supplier accounts are paid in full prior to submitting the high credit supplier accounts to Duns 920. The applicant will subsequently verify that each high credit supplier as net 30 accounts 925 and that the supplier has not reported past due 930. The applicant will then verify the supplier has a sale date within 12 months 935, that the suppliers files are complete 940 and to be positive 945. The high credit supplier accounts will be submitted to Duns for a PAYDEX score 955 and Duns will receive the suppliers account information and one or more business entities obtains a PAYDEX score.

The Applicant's business credit history would be particularly impressive if at least one of his vendors reports a high dollar amount for the high credit. Having four suppliers report prompt payments with low dollar amounts will get the Applicant a PAYDEX score of 80, but will not provide the creditability necessary to get approved for business credit lines with credit limits as high as $50,000. Banks want to see that the Applicant's company not only has an 80 PAYDEX score, but also has experience serving high dollar amounts of at least $30,000. A sufficient high dollar amount would be any amount approximately $25,000 or higher.

If the Applicant's company gets an 80 PAYDEX score but not have a reference with a high dollar amount, it does not mean that his company will not get business credit lines, but it does mean that the credit limits for each account may be substantially less than if his company had a least one supplier with a high dollar amount.

Dun & Bradstreet will verify that the Applicant's company's has a business license in the city where the business office is located and verify the company's phone number is published in the 411 directory when he orders the Credit Builder service. Thus, it is extremely important that the Applicant verify that his company's phone number, street address, city, state, and zip code are published in the 411 directory before ordering the credit builder service. He verifies the listing by calling 411 and asking the operator for the city, state, zip, and phone number for his company. If the operator confirms that his company's address (the number and street name) and phone number appear, then he has verified the listing. If not, he calls the phone company to be sure the information is listed in the 411 directory.

Dun & Bradstreet will provide the Applicant with an “e-update” password once his company's Duns file becomes complete. An e-update password allows the Applicant to view his company's Duns report free of charge. He views his report by visiting www.dnb.com/eupdate. He types his Duns number and e-update password in the appropriate boxes to view the report.

The Applicant verifies for himself that he has an 80 PAYDEX score, and looks at the start date that the report lists for his company. In all likelihood, it will reflect the current year. The Applicant calls Dun & Bradstreet e-update department in order to correct the company's sales figures if they are not listed accurately, to provide the representative with the file number and date of the aged business entity as well as the name of the appropriate government agency where the representative can verify the filing.

Sales Projections. Banks typically grant a credit limit on a business credit line approvals based upon 10% of the Applicant's company projected sales. If he projects his company's sales at $250,000, banks will most likely grant his company a $25,000 credit limit. Likewise, if he projects his company's sales at $1 million, banks will most likely give him a $50,000 credit limit.

WHERE TO SUBMIT YOUR APPLICATIONS. Before the Applicant submits his applications for business credit lines, he must have completed the following tasks:
Created a Duns Report with an 80 PAYDEX score, sales figures, and history
Removed unauthorized credit inquiries on guarantor's personal credit report
Increased high credit as high as possible on guarantor's credit report
Paid off credit card balances to zero ($0) on guarantor's personal credit report

The Applicant will need to apply for some business credit cards before applying for business credit lines if he lacks sufficient funds to pay off his credit card balances. It is not sufficient for the guarantor's credit card companies to show a zero balance. The zero balance must be updated on the guarantor's credit report.

Credit card issuers typically update balances with the credit bureaus about a week after the credit card statement closes, which is once a month. If the Applicant pays down the credit card balances within a week or so from the close of the next statement, he contacts the credit bureaus about a week after the statement closes to verify that the balances reflect a zero balance. If the statement is scheduled to close more than week from the time he pays down the balances, he contacts the credit bureaus to dispute the balances to zero.

The bureaus will contact the credit card issuers to verify the updated balances. Usually, the balances are updated within two to four weeks from the date he initiates the dispute; however, it can happen sooner.

Once the Applicant has completed all of the tasks listed in the aforementioned bulleted list, he is ready to submit business credit line applications. Most banks require businesses to submit two years' worth of financial statements and tax returns with the credit line applications. Some banks have “credit-score-based” credit line applications.

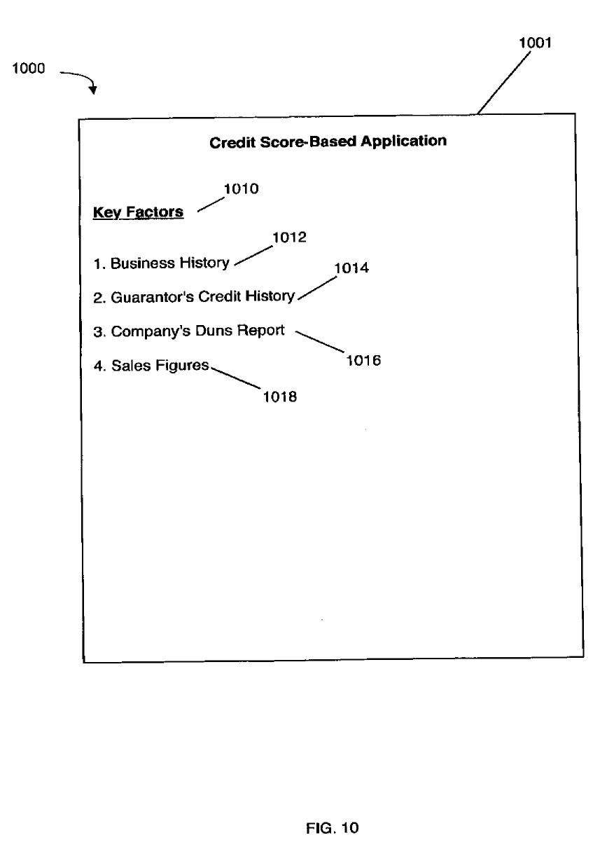

Credit-score-based applications as shown in FIG. 10 do not require tax returns or financial statements when applying for a credit limit of up to $50,000; some banks will go up to $ 100,000. Referring to FIG. 10, this type of application 1001 is evaluated by four key factors 1010: 1) business history 1012, 2) guarantor's credit history 1014 3) company's Duns report 1016 and 4) sales Figures 1018. In addition to the national banks, the Applicant finds banks in his area that offer similar products.

The Applicant then submits applications to multiple (usually five) different banks simultaneously; usually not more than five at a time because bank underwriters become suspicious as to the many credit inquiries on the guarantor's personal credit report in such a short period of time.

Once the Applicant gets approved with the initial said number of banks listed, he disputes the inquiries made on the guarantor's personal credit report related to the first said number of applications using the affidavit and filing police report method previously discussed. The credit bureaus normally delete the credit inquiries within 30 days from the date they receive the dispute. If the Applicant does not wish to dispute them with the affidavit and police report method, he waits 90 days from the date of the last inquiry to apply for business credit lines at multiple (usually five) other banks. The Applicant repeats the process of applying for business credit lines or credit cards at every bank he can find that has credit-score based credit lines as well as business credit cards.

HOW TO HAVE YOUR CREDIT LIMITS INCREASED. The banks will increase the Applicant's credit limits if he services the credit line debt in a specific manner. The banks like to see that he uses the lines and pays most, if not all, of the principal balances off each month. If he maxes out his lines and makes interest only payments over the course of several months, then he gives the impression that his business does not generate enough cash flow to pay back the principal amounts his company borrowed.

If the Applicant is using the credit lines to fund the purchase of a property and is not able to make payments toward the principal balance each month, he pays the interest from his company's rental income. He makes separate principal payments each month by balance transferring from another credit line. For example, assume the Applicant has a $50,000 credit line from Bank A and another from Bank B. His Bank A credit line has a $50,000 balance. He receives a statement saying that his minimum payment is $417 (interest only). He pays the $417 from his company's rental income. He then writes a check for $50,000 from his Bank B credit line, which pays off the principal in full on Bank A's credit line.

The next month he pays the interest on the Bank B account from his company's rental income and pays off the principal balance from Bank A's credit line. Each month he pays the principal of one credit line from another. After repeating this process for a number of months (usually four to six months), he asks each creditor for a credit line increase.

It should take the Applicant about three to four months to establish his Duns report, make the necessary improvements on the guarantor's credit report, and submit a set of said number (usually five) applications. The time frame can vary, though, based upon each Applicant's circumstances.

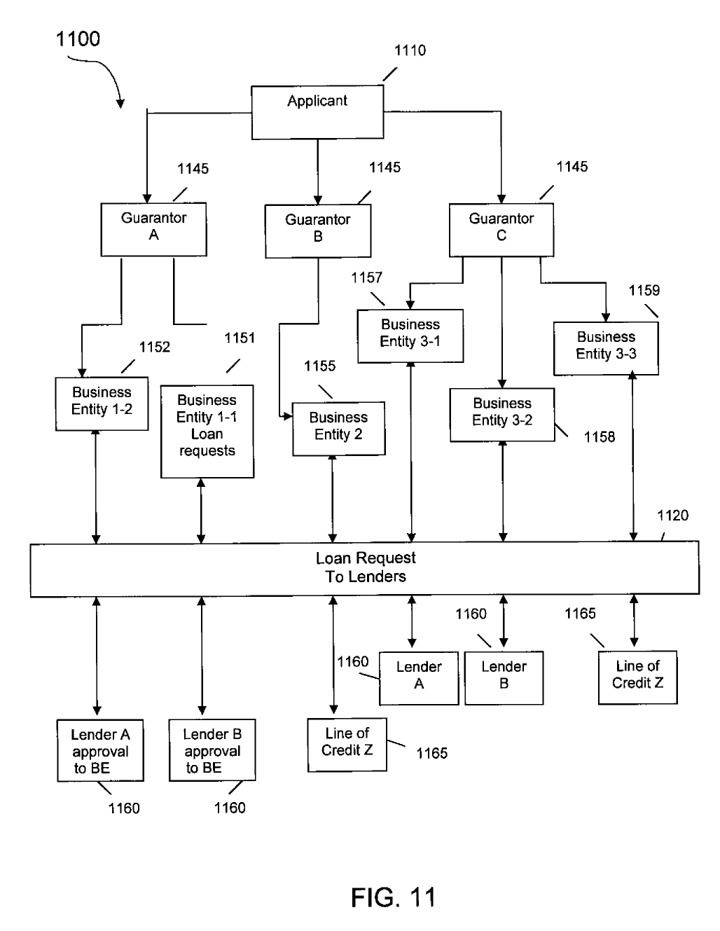

If the Applicant wishes to establish a substantial amount of credit quickly, he finds multiple guarantors to build credit lines to multiple companies, simultaneously as shown in FIG. 11. For example, an Applicant can find 10 different personal guarantors in various aspects of the methods and systems, setting up Duns reports and separate lines of credit for each of the 10 separate companies, thereby maximizing high credit accounts in certain aspects of the embodiments.

As shown in the block diagram on FIG. 11, the present system 1100 depicts the relationship between the one or more entities used to expand the amount of available credit. The applicant 1110 has a working relationship with any number of business entities 1151, 1152, 1155, 1157, 1158, and 1159 through an intermediate guarantor 1145. The applicant makes a loan request 1120 through a great number of business entities 1151-1159. The loan request 1120 may result in the approval of the requested credit line(s), if approved by a lender 1160. A line of credit 1165 may also be arranged that is either secured or unsecured 1165.

The applicant 1110 may have business relationships with a number of business entities 1151-1159. These business entities 1151-1159 can be represented as a vector. The business entities 1151-1159 subsequently apply for a number of business lines of credit 1160 through a series of loan requests utilizing one or more business entities 1151-1159 and one or more guarantors 1145 as shown in an exemplary method in FIG. 11. As shown in this exemplary system, in certain aspects the amount of credit available is the sum of all lender loan approvals 1160 (a . . . b, etc.) and secured or unsecured lines of credit Z 1165 for each business entity 1151-1159.

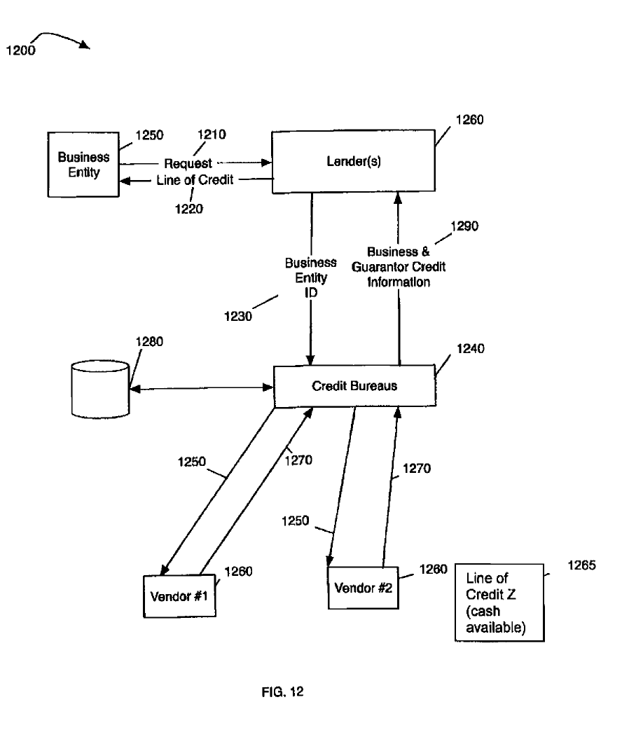

Now referring to FIG. 12, a system diagram 1200 is shown indicating the relationship between the business entity 1250, and the line of credit 1220. The business entity 1250 will make a credit request 1210 from an institution that provides a line of credit 1260 (typically a bank). The line of credit lender 1260 (e.g. bank), will make a request 1230 to business credit scoring companies 1240 (e.g. Dun & Bradstreet, Experian Business, Trans Union Business, and/or Equifax Business) and personal credit scoring companies 1240 (e.g. personal credit scoring company, e.g. Experian, Equifax, and Trans Union) to determine the credit worthiness of the business. The business credit scoring companies 1240 will subsequently determine the business credit score based on current and historical inquiries 1250 to a multiplicity of vendors 1260. The vendors will return a list of transaction experiences 1270 regarding the particular business entity 1250. The personal credit scoring companies 1240 will subsequently determine the personal credit score of the guarantor based on current and historical inquiries 1250 to a multiplicity of vendors 1260. The vendors will return a list of transaction experiences 1270 regarding the particular personal guarantor.

One of the other indicators 1280 used by the business credit scoring 1240 is the length of time the business entity 1250 has been in existence amongst other factors. By optimizing each of these factors, the business credit score 1290 will be increased.

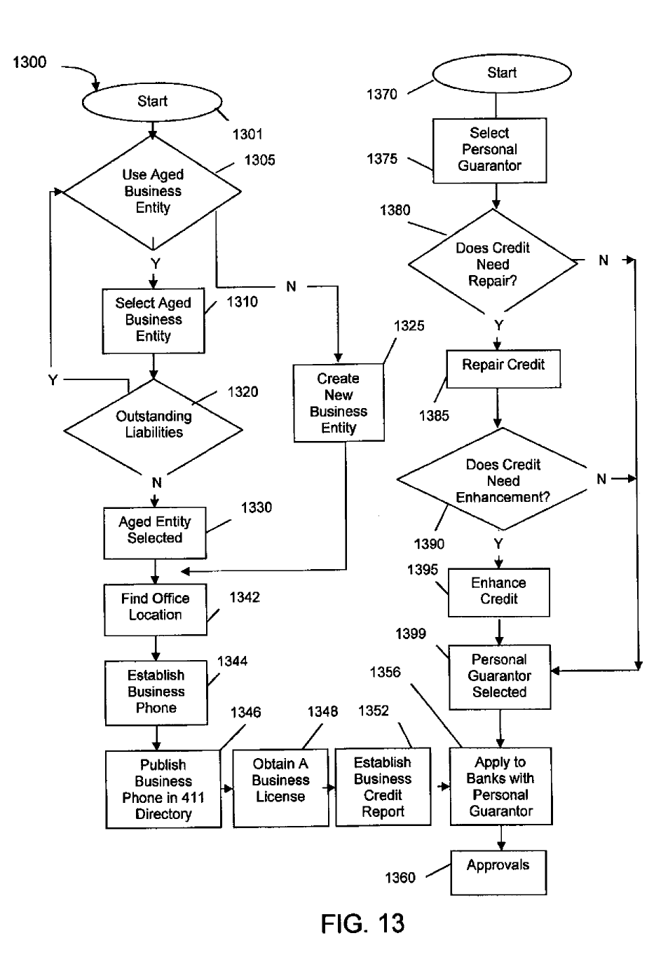

Now referring to FIG. 13. Wherein 1300 depicts the method of the selecting of an aged business entity, improving its personal credit score by first determining whether the personal guarantor credit needs enhancement 1390 then a method of credit enhancement 1395 is employed as well as the selecting and evaluating of the credit score of the personal guarantor 1399 and subsequently applying to banks 1356 to obtain one or more approvals 1360. The first step 1305 is to decide whether an aged business entity will be used. If so, an aged business entity is selected 1310, then the aged business entity is examined 1320 to determine if it has any liabilities (e.g. outstanding liens, judgments) 1320 by searching either the court records or private credit reporting companies (e.g. DUNS report at www.dnb.com and Experian Business at http://www.smartbusinessreports.com/?link=5002&offercode=bsdropdownsbrm). If the aged business entity has no liabilities, then it is selected 1330.

The next step is to establish a professional business presence, which consists of locating a physical business office 1342 and establishing a business phone 1344, street address, city, state, zip, in the 411 directory 1346. Establishing a professional business presence also includes the steps of obtaining a business license 1348 in the city where the business is located.

The next step is to obtain a business license 1348, then update or establish a business record with the business credit scoring company 1352. This consists of reporting the business information to the credit scoring company and indicating the personal guarantor 1356 to the credit scoring company. At this point in the parallel process, once a credit repair process 1385 and credit enhancement process 1395 is completed, an application to banks with one or more personal guarantors' is completed 1356 and subsequent approvals 1360 are obtained.

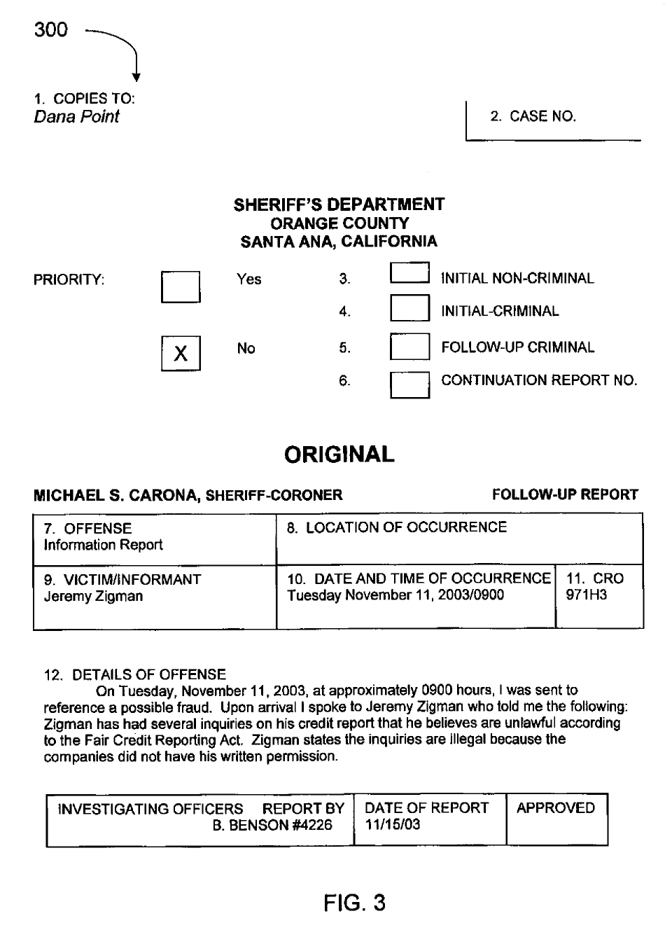

Now referring back to FIG. 8, the selection of the personal guarantor 800, 810 is done in parallel with the selection of the aged business entity 1300 as shown in FIG. 13. The first step is to select a personal guarantor 810 and check if credit repair is needed 820. If required, the guarantor's credit is repaired 830. The next step is to determine if the personal guarantor's credit needs to be enhanced 840. If so, the credit is enhanced 850. Finally a personal guarantor is selected and used for the loan application process 356 as also shown in FIG. 3.

Now referring to FIGS. 12 and 13, a process is shown to obtain a line of credit 1260. After the business entity 1250 has been established, then a block of unsecured credit lines are applied for in the business entity 1250 as described in FIG. 12. Approvals 1360 for a block of credit cards (usually five to ten), as shown in FIG. 13, are obtained from line of credit (cash available) providers (i.e. lenders) 1265, as shown in FIG. 12. Vendors 1260 sometimes function as lenders to receive loan requests from one or more business entities 1151-1159 and provide the one or business entities with loan approvals and grants.

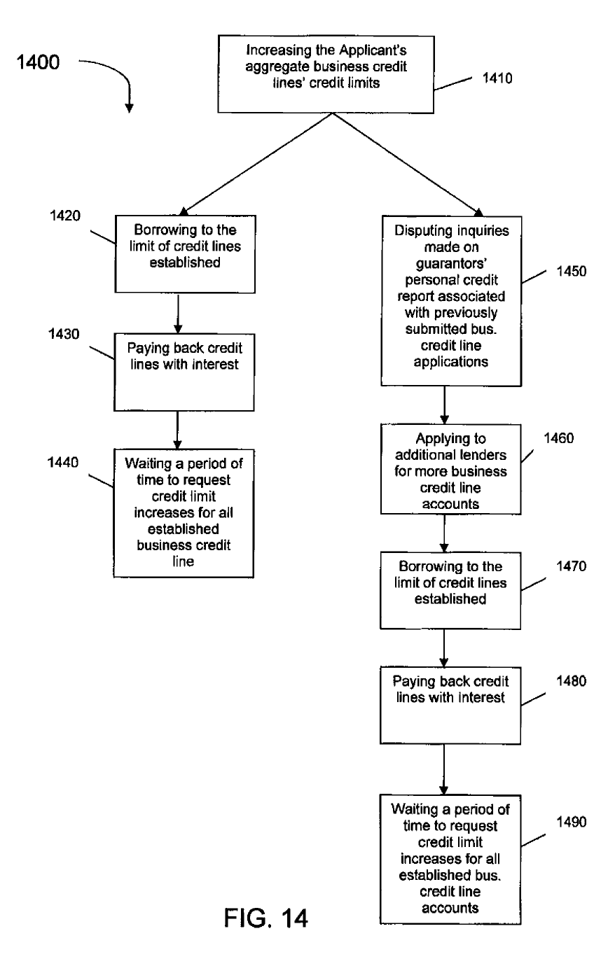

Now referring to FIG. 14. The business applicant increases their aggregate business credit lines' credit limits 1410. The progression thereafter can split in two separate directions. The first direction has the applicant borrowing to the limit of the established credit lines 1420, then paying back the borrowed credit with interest 1430. Finally, the applicant waits a period of time to request a credit limit increase for all the established business credit lines 1440. The second direction has the applicant disputing inquiries made on the guarantors' personal credit report which were associated with previously submitted business credit line applications 1450. The applicant then applies to additional lenders for more business credit line accounts 1460 and then borrows to the limit of credit lines established 1470. The applicant then pays back established credit lines with interest 1480 and waits a period of time to request credit limit increases for all established business credit line accounts 1490.

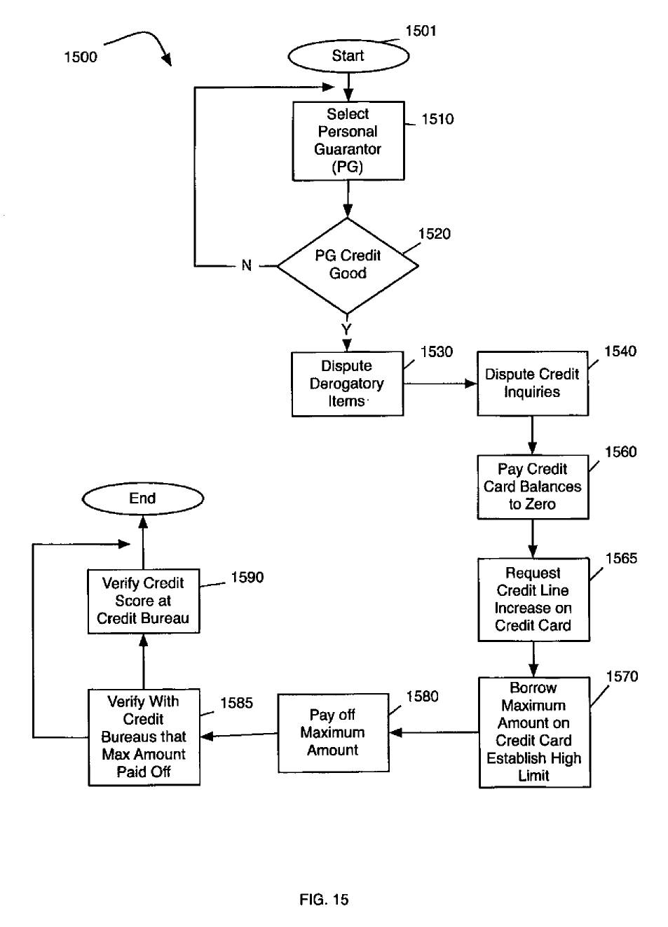

One of the important indicators in the business credit scoring 1240, as shown in FIG. 12, is the credit worthiness of the personal guarantor (PG) of the business entity. Therefore it is necessary to select a personal guarantor that has a high personal credit score. The process 1500 of selecting a good personal guarantor (PG) as well as improving the credit rating of the PG is shown as a flowchart in FIG. 15. The first step 1510 is to select one or more personal guarantors. In the next step 1520 the credit worthiness of the one or more personal guarantors is evaluated. For example, it may desirable for the one or more personal guarantors to have minimal or no derogatory items on their credit report. If the initial credit score of the applicant does not meet this threshold value then a new personal guarantor is selected 1520. Otherwise, the one or more personal guarantors dispute all derogatory items 1530.

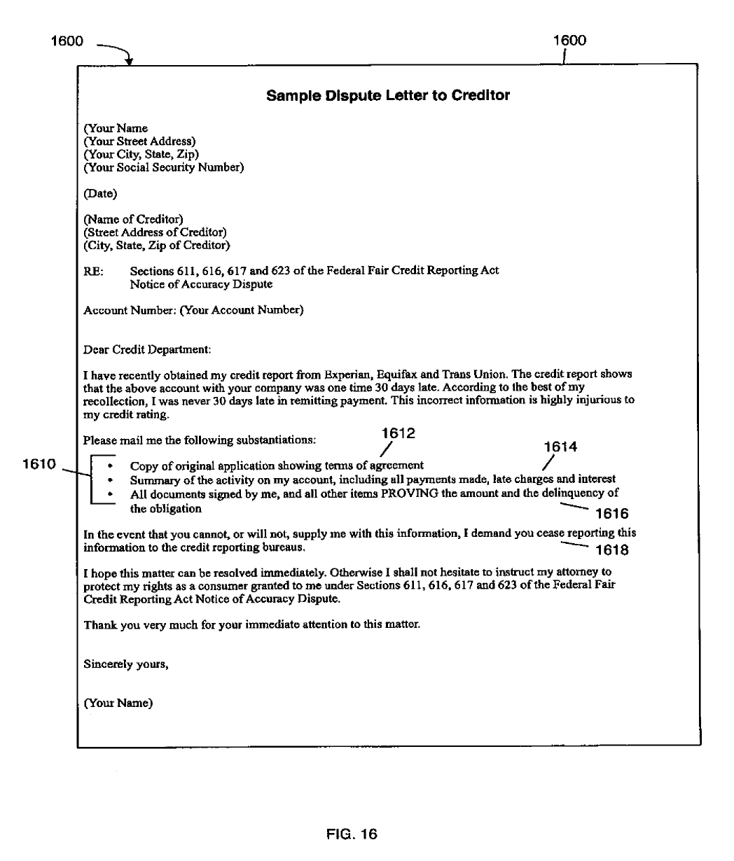

A sample dispute letter detailed process is shown in FIG. 16 corresponding to the sample dispute letter shown in FIG. 2. The personal guarantor substantiation list 1610 is shown for a particular disputed creditor, including agreement terms 1612, account activity summary 1614, signed documents by the borrower 1616, and a demand to cease reporting should the substantiation list not be provided 1618. In addition to disputing the personal guarantor's derogatory items, the personal guarantor's credit inquiries are disputed 1540 as shown on FIG. 15. Concurrently all balances are paid off until there is no credit balance 1560. Once the credit balance is zero 1560, the PG requests an increase in the credit line 1565 to the highest limit possible 1570 (usually up to $35,000) from one or more of his personal credit cards. The “high credit” is established 1570 when the PG borrows up to the maximum amount on the credit card that was previously increased. This maximum amount is subsequently paid off 1580. Next, the personal guarantor verifies that the maximum amount high credit accounts have actually been paid off 1585 prior to optionally verifying score at the credit bureau 1590. The guarantor's credit score increases after the credit balance is zero and the credit inquiries have been removed. The personal guarantor verifies with the credit bureaus 1590 that all disputes (derogatory, inquiries) and credit card balances have been updated on to his credit report utilizing an automated credit report update verification template form.

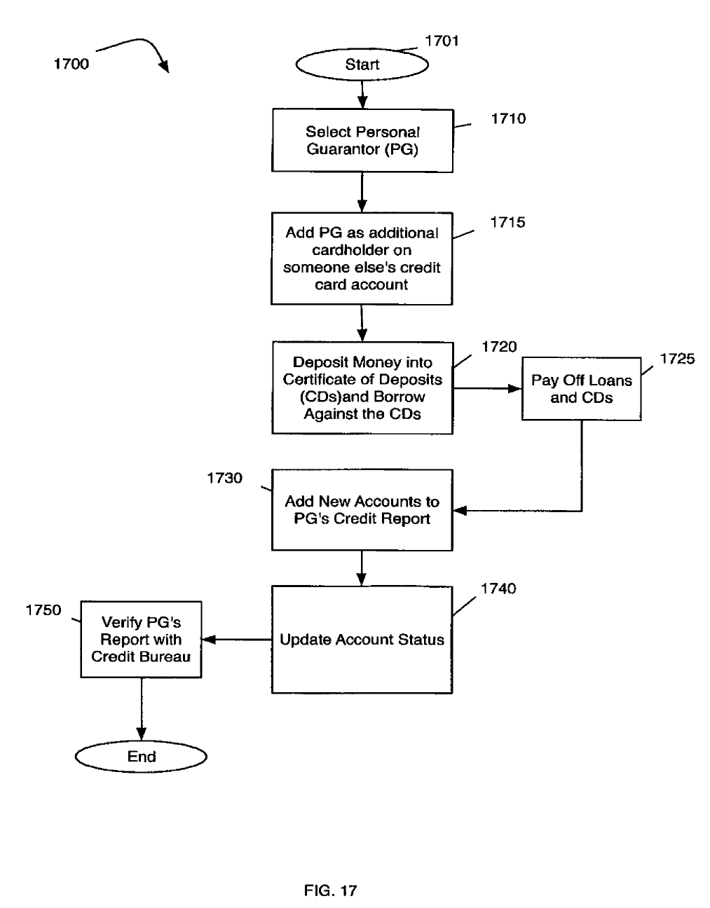

Now referring to FIG. 17, the process of credit enhancement 1700 is shown. The first step is to select the personal guarantor 1710. The next step is to add the personal guarantor as an additional cardholder on another person's credit card accounts 1715. The next step 1720 is to deposit money into certificate of deposit and then borrow against the amount placed into the certificate of deposits. The next step is to pay off loans and CD's 1725, then to add the new accounts 1730 to the guarantor's credit report. After the new accounts are added, the statuses of the accounts are updated 1740. Account updating is followed by a process of verifying the status of the guarantor's accounts with the credit bureau 1750. For each step in the aforementioned process, a check with the credit bureaus must be performed to verify that the information has been transmitted to the credit bureau and updated on the personal guarantor's credit report.

Now referring back to FIG. 11, an overview of the maximum loan amount is shown. The line of credits 1160 for each business entity having been maximized, the applicant 1110 can borrow the maximum amount from each business entity to fund a particular venture. Vendors 1260 sometimes function as lenders to receive loan requests from one or more business entities 1151-1159 and provide the one or business entities with loan approvals and grants.

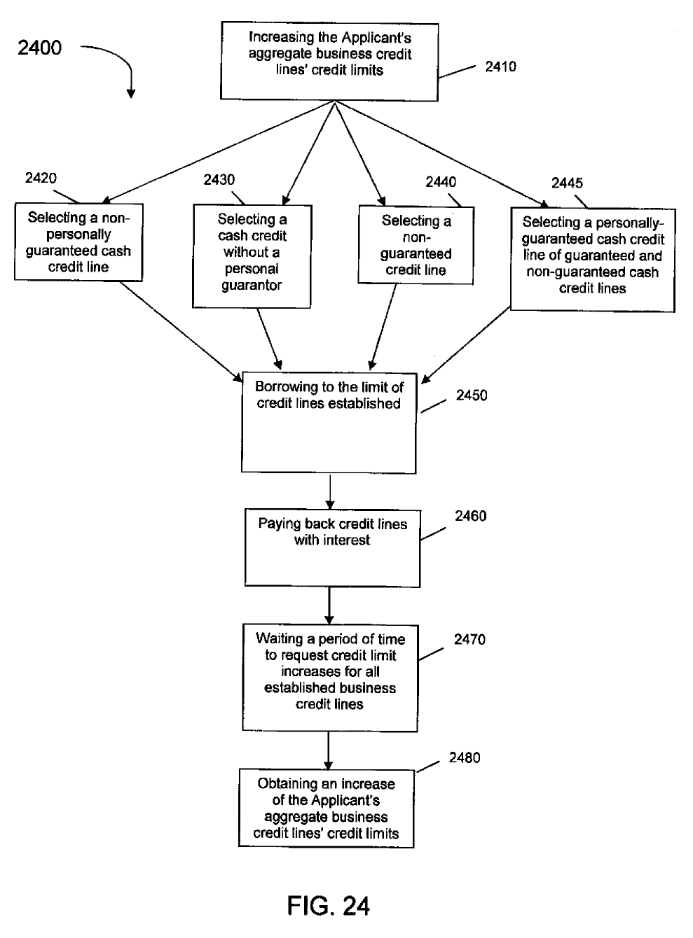

Referring to FIG. 24, the process of credit enhancement 2400 is shown. The first option is to select the non-personally guaranteed cash credit line 2420, a cash credit without a personal guarantor 2430, a non-guaranteed credit line 2440 or a personally-guaranteed cash credit line of guaranteed and non-guaranteed cash credit lines 2445. The applicant borrows to the limit of credit lines established 2450. The applicant then pays back said credit lines with interest 2460. Next, the applicant waits a period of time to request credit limit increases for all established business credit lines 2470. Finally, applicant obtains an increase of the aggregate business credit lines' credit limit 2480.

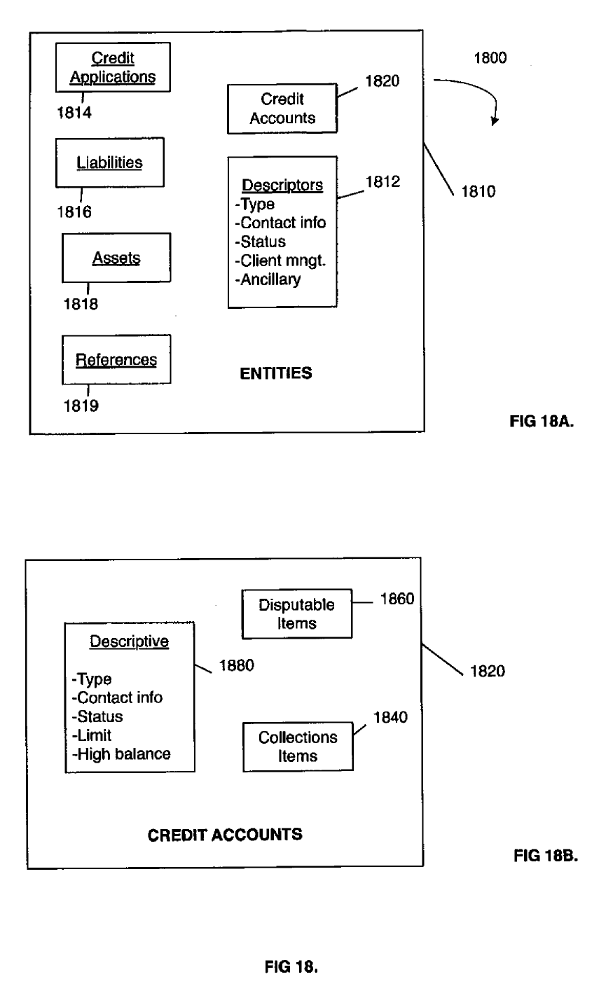

FIGS. 18A-18B are conceptual diagrams of the data relationships created and used by the system of the present exemplary embodiments shown to track client credit enhancement and repair activities. In the center of the diagram 1 8A, data record types 1810 are shown, where a data record is defined as either a fiduciary, a business holding or a personal guarantor. Each data record type 1810 has one and only one descriptive data record 1812, leading to a one to one relationship, between the field data record type 1810 and the field descriptive data record 1812, including Entity Type, Contact Information, Status, Client Management Information and Ancillary data. Further, the field descriptive data record 1812 may also include related metadata to the data set.

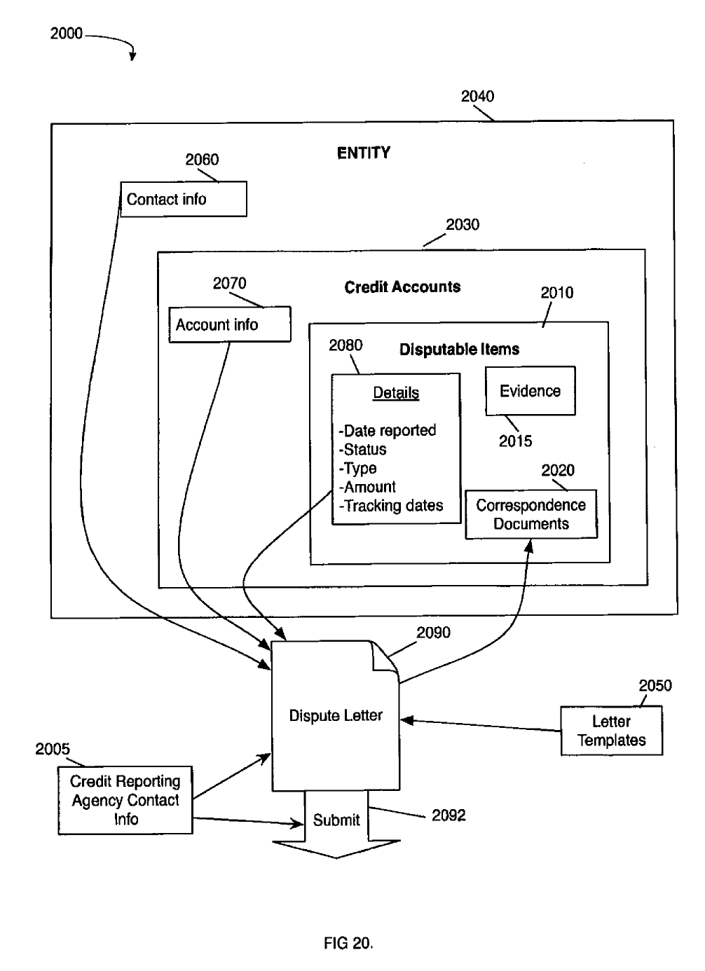

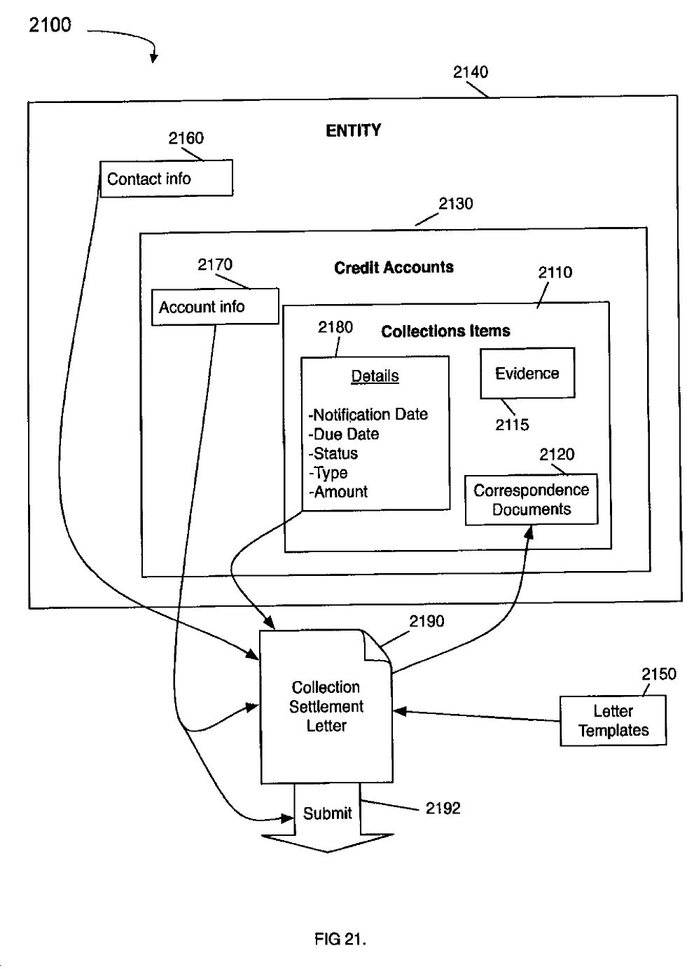

Now referring to FIG. 20, credit accounts 1820, 2030 have zero to many Disputable Items 1860 as also shown in FIG. 18B, which are gathered from credit reports. Disputable Items 1860 are late payments, defaults, foreclosures, and other derogatory remarks found on credit reports that are addressed directly with credit reporting agencies. Referring to FIG. 21, credit Accounts 1820 also have zero to many Collections Items 1840. Collections Items 1840 are accounts that have been placed in a collections status by the creditor and may or may not have already been reported to credit reporting agencies.

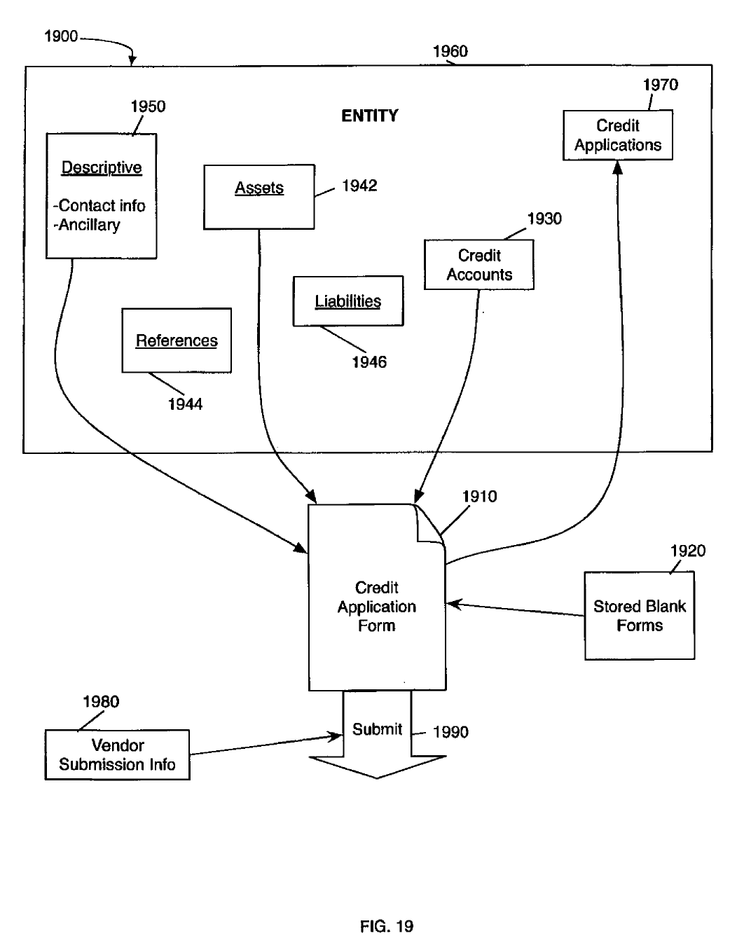

FIG. 19 is another conceptual diagram of the method steps of the present invention to track client credit enhancement activities describing associating records related to an applicant 1810 to a linked Credit Application 1870, shown along with a representation of how the data is used to automatically fill out credit applications for an applicant. Filling out a multiplicity of application forms all requiring the same information by hand is tedious and repetitive. It is also prone to error, which negatively affects the client's ability to obtain the credit they are applying for. Finally, the process is time-consuming, which results in higher costs to pass along to clients. Scanning application forms and manipulating them to automatically fill in all of the required information in the correct fields, and storing said scanned and manipulated forms for retrieval by a program that automatically populates the fields is critical to managing the quality, timeliness and cost-effectiveness of the business methods of the present invention. Credit applications 1910 require a very standardized set of information including contact information 1950 associated with an Entity 1960, and years at current address and other ancillary data 1950 associated with said Entity 1960. Assets 1942 such as bank accounts and liabilities 1946 such as regular payments for services related to an Entity 1960 are also required to consider an application for credit approval. A number of personal and business references 1944 willing to vouch for the Entity 1960 are also generally required. A complete listing of all current credit accounts 1930 associated with said Entity 1960 and their limits, high balances and other descriptive information are also necessary. All of this information is passed to the scanned form 1920 upon retrieval. Once the application 1910 has been reviewed and any changes made and additional information provided, the document 1910 is stored as a completed Credit Application 1970, associated with the Entity 1960. Once completed and approved, the application 1910 can also be automatically submitted 1990 by the system disclosed herein, if an electronic means of submission, such as via fax, email or a URI, is available in the credit vendor information 1980.

FIG. 20 is yet another conceptual diagram of the method steps of the present invention to track client credit enhancement activities, describing the Credit Account-related 1820 Disputable Items 1860 information, also shown along with a representation of how the data is used to automatically fill out Dispute Letters 2090 for an Entity 2040. Most information in a Dispute Letter 2090 is highly formulaic. The address and name 2060 associated with the Entity 2040, the credit reporting agency name and address 2005 reporting the Disputable Item 2010, the details 2080 describing the Disputable Item 2010, and the Credit Account information 2070 associated with the Credit Account 2030 that the Disputable Item refers to are always required in a. Dispute Letter 2090. Further, the basic content of dispute letters are boilerplate text regarding the type of dispute with statutory language. The invention of the present disclosure stores these dispute Letter Templates 2050. All of this information is passed to the appropriate Letter Template 2050 retrieved, whereupon a word processing document 2090 is created. Once the letter 2090 has been reviewed and any changes made and additional information provided, the document 2090 is stored 2092 as a completed Correspondence Document 2020, associated with the Disputable Item 2010. Evidence 2015, if any, is associated with the Disputable Item 2010. Once completed and approved, the letter 2090 and any associated evidence 2015 can also be automatically submitted 2092 by the system disclosed herein, if an electronic means of submission, such as via fax, email or a URI, is available in the credit reporting agency information 2005.

FIG. 21 is still another conceptual diagram of the method steps of the present invention to track client credit enhancement activities, this time describing the Credit Account-related 1820 Collections Items 1840 information, also shown along with a representation of how the data is used to automatically fill out Collection Settlement Letters 2190 for an applicant 2140. Most information in a Collection Settlement Letter 2190 is highly formulaic. The address and name 2160 associated with the Entity 2140, the details 2180 describing the Collections Item 2110, and the Credit Account Information 2170 for the Credit Account 2130 are always required in a Collection Settlement Letter 2190. Further, the basic content of settlement letters are boilerplate text presenting the terms of settlement with statutory language. One embodiment of the present disclosure stores the corresponding settlement Letter Templates 2150. All of this information is linked and presented to the appropriate Letter Template 2150 and retrieved, whereupon a word processing document 2190 is created. Once the letter 2190 has been reviewed and any changes made and additional information provided from a plurality of external sources selected by the user, the document 2190 is stored as a completed Correspondence Document 2120 in an evidence and support file, associated with the Collections Item 2110. Evidence 2115, if any, is associated with the Collections Item 2110. Once completed and approved, the letter 2190 and any associated evidence 2115 can also be automatically submitted 2192 by the system disclosed herein, if an electronic means of submission, such as via fax, email or a URI, is available in the Credit Account information 2170.

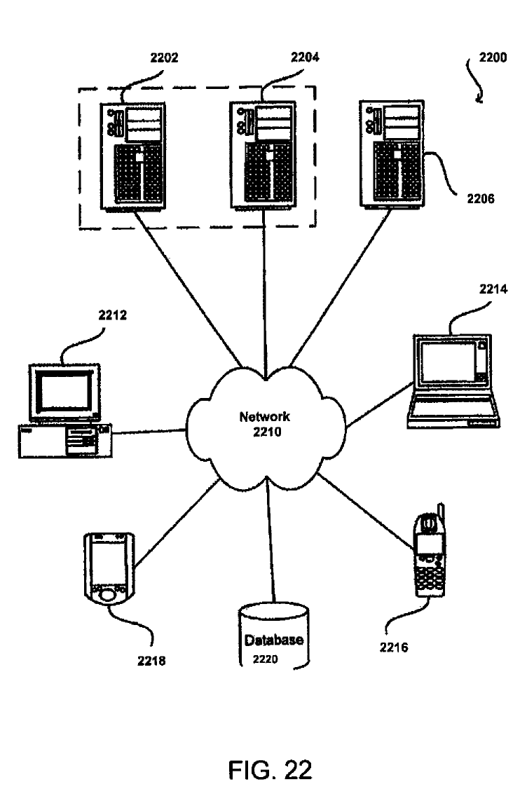

Exemplary Operating Environments, Components, and Technology FIG. 22 is a block diagram illustrating components of an exemplary operating environment in which various embodiments of the present methods may be implemented. The system 2200 can include one or more user computers, computing devices, or processing devices 2212, 2214, 2216, 2218, which can be used to operate a client, such as a dedicated application, web browser, etc. The user computers 2212, 2214, 2216, 2218 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 2212, 2214, 2216, 2218 may also have any of a variety of applications, including one or more development systems, database client and/or server applications, and Web browser applications. Alternatively, the user computers 2212, 2214, 2216, 2218 may be any other electronic device, such as a thin-client computer, Internet-enabled gaming system, and/or personal messaging device, capable of communicating via a network (e.g., the network 2210 described below) and/or displaying and navigating Web pages or other types of electronic documents. Although the exemplary system 2200 is shown with four user computers, any number of user computers may be supported.

In most embodiments, the system 2200 includes some type of network 2210. The network may can be any type of network familiar to those skilled in the art that can support data communications using any of a variety of commercially-available protocols, including without limitation TCP/IP, SNA, IPX, AppleTalk, and the like. Merely by way of example, the network 2210 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 2202.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 2202, 2204, 2206 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 2206) may be dedicated to running applications, such as a business application, a Web server, application server, etc. Such servers may be used to process requests from user computers 2212, 2214, 2216, 2218. The applications can also include any number of applications for controlling access to resources of the servers 2202, 2204, 2206.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 2212, 2214, 2216, 2218. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 2212, 2214, 2216, 2218.

The system 2200 may also include one or more databases 2220. The database(s) 2220 may reside in a variety of locations. By way of example, a database 2220 may reside on a storage medium local to (and/or resident in) one or more of the computers 2202, 2204, 2206, 2212, 2214, 2216, 2218. Alternatively, it may be remote from any or all of the computers 2202, 2204, 2206, 2212, 2214, 2216, 2218, and/or in communication (e.g., via the network 2210) with one or more of these. In a particular set of embodiments, the database 2220 may reside in a storage-area network (“SAN”) familiar to those skilled in the art. Similarly, any necessary files for performing the functions attributed to the computers 2202, 2204, 2206, 2212, 2214, 2216, 2218 may be stored locally on the respective computer and/or remotely, as appropriate. In one set of embodiments, the database 2220 may be a relational database, such as Oracle 10g, that is adapted to store, update, and retrieve data in response to SQL-formatted commands.

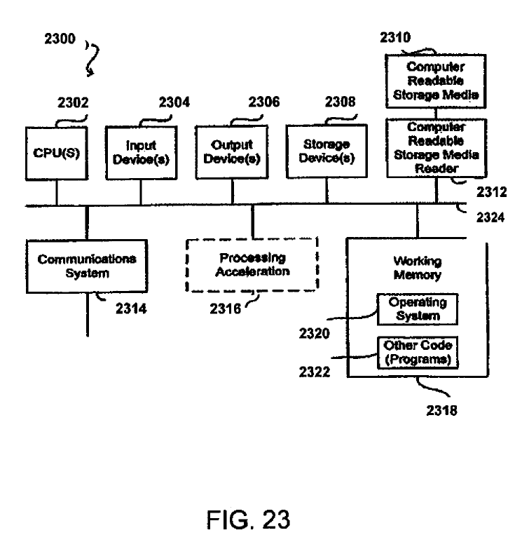

FIG. 23 illustrates an exemplary computer system 2300, in which various embodiments of the present invention may be implemented. The system 2300 may be used to implement any of the computer systems and methods described above. The computer system 2300 is shown comprising hardware elements that may be electrically coupled via a bus 2324. The hardware elements may include one or more central processing units (CPUs) 2302, one or more input devices 2304 (e.g., a mouse, a keyboard, etc.), and one or more output devices 2306 (e.g., a display device, a printer, etc.). The computer system 2300 may also include one or more storage devices 2308. By way of example, the storage device(s) 2308 can include devices such as disk drives, optical storage devices, solid-state storage device such as a random access memory (“RAM”) and/or a read-only memory (“ROM”), which can be programmable, flash-updateable and/or the like.

The computer system 2300 may additionally include a computer-readable storage media reader 2312, a communications system 2314 (e.g., a modem, a network card (wireless or wired), an infra-red communication device, etc.), and working memory 2318, which may include RAM and ROM devices as described above. In some embodiments, the computer system 2300 may also include a processing acceleration unit 2316, which can include a digital signal processor DSP, a special-purpose processor, and/or the like.

The computer-readable storage media reader 2312 can further be connected to a computer-readable storage medium 2310, together (and, optionally, in combination with storage device(s) 2308) comprehensively representing remote, local, fixed, and/or removable storage devices plus storage media for temporarily and/or more permanently containing, storing, transmitting, and retrieving computer-readable information. The communications system 2314 may permit data to be exchanged with the network and/or any other computer described above with respect to the system 2300.

The computer system 2300 may also comprise software elements, shown as being currently located within a working memory 2318, including an operating system 2320 and/or other code 2322, such as an application program (which may be a client application, Web browser, mid-tier application, RDBMS, etc.). It should be appreciated that alternate embodiments of a computer system 2300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate.

In summary, systems and methods for establishing business credit and improving personal credit described herein can be seen as comprised of five main parts. First, there is the method for applying and establishing an unsecured business credit line that may begin by establishing a business entity and reporting the business entity to a credit scoring company. Second are the methods for increasing the credit limit, which can include maintaining a minimum credit score of 80 in an exemplary embodiment. Next, an exemplary embodiment is disclosed wherein an applicant may dispute inquiries made by lenders and other institutions to credit scoring companies until inquiries are removed. Finally, the exemplary systems and methods are implemented for establishing business credit and improving personal credit that allows software program code to provide instructions to perform the exemplary methods and also provides the system infrastructure and communication for managing credit enhancement services that stores, accesses and manipulates data.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

While the inventor understands that claims are not a necessary component of a provisional patent application, and there has not included detailed claims, the inventor reserves the right to claim, without limitation, the following subject matter.

What is claimed is:

1. A method for establishing the amount of unsecured business credit comprising the following steps in any order:
establishing one or more personal guarantor(s);
establishing one or more business entities;
establishing a professional business presence for said one or more business entities wherein said professional business presence includes obtaining a business license in the city where the business office is located, providing said one or more business entity's company's official office address accompanied by said one or more business entity's company listing in the local 411 directory;
reporting the professional business presence and the one or more personal guarantors to one or more credit scoring companies;
establishing a PAYDEX score of said one or more business entities to a minimum of 80; and
applying for and establishing one or more business credit lines wherein said one or more credit lines can be one or more credit cards;
wherein said method for establishing the amount of unsecured business credit is determined by one or more credit line providers reviewing external data about the one or personal guarantor(s) and the one or more business entities and wherein said applicant may obtain said credit lines at more favorable contract terms.

2. The method of claim 1 for establishing the amount of unsecured business credit wherein establishing said one or more business entities further comprises selecting one or more aged business entities that is at least two years old with no liabilities.

3. The method of claim 2, further comprising:
establishing said one or more business entities wherein establishing said one or more business entities further comprises selecting said one or more aged business entities that is at least two years old with no liabilities, and increasing the credit scores of the one or more personal guarantors through a credit repair process wherein the credit repair process is accomplished in part by disputing any derogatory items on the one or more personal guarantors' credit report with a credit scoring agency and disputing any credit inquiries on the one or more personal guarantors' credit report with a credit scoring agency until said inquiries are removed.

4. The method of claim 3, further comprising the following steps in any order:
performing a credit enhancement process wherein said method includes the following steps in any order:
selecting a personal guarantor(s) with an acceptable credit score;
selecting a guarantors' personal revolving credit line;
applying for an increase in the credit limit of said personal revolving credit line;
borrowing the maximum amount from the personal revolving credit line; and
paying off said credit line.

5. The method of claim 4, further comprising:
increasing the credit score of the one or more personal guarantors through said credit enhancement process.

6. The method of claim 5 wherein the credit enhancement process is accomplished in part by selecting one or more of the personal guarantor's personal credit lines and applying for an increase in the credit limit of said credit line and wherein increasing the credit limit of said personal guarantor's personal credit lines to the maximum allowable amount maximizes the positive impact on the personal guarantors' personal credit rating and further comprising the following steps in any order:
borrowing the maximum amount from said credit line;
paying off the said personal guarantor's personal revolving credit lines' balance(s); and
establishing one or more new high credit line credit accounts.

7. The method of claim 6, further comprising:
increasing said one or more personal guarantors credit score wherein said increased credit score provides a larger credit amount for said one or more business entity unsecured credit lines.

8. The method of claim 7 wherein the credit limits of said one or more business credit lines are increased in response to applicant's request.

9. The method of claim 1 wherein said establishment of a professional business presence includes business license in the city where the business office is located, providing said one or more business entity's company's official office address accompanied by said one or more business entity's company listing in the local 411 directory.

10. The method of claim 1, further comprising a method of credit enhancement including the following steps in any order:
selecting a personal guarantor(s) with an acceptable credit score;
selecting a guarantors' personal revolving credit line;
applying for an increase in the credit limit of said personal revolving credit line;
borrowing the maximum amount from the personal revolving credit line; and
paying off said personal revolving credit line.

11. The method of claim 10 wherein paying off said personal revolving credit line thereby increases the high credit amount of said personal guarantors' unsecured, revolving credit lines.

12. The method of claim 10, further comprising:
establishing one or more newly opened credit accounts and maintaining said accounts in good standing;
establishing one or more newly opened high credit account;
adding one or more new unsecured credit accounts;
paying down one or more of the personal guarantor's unsecured, revolving credit card balances;
borrowing money from funds invested in one or more certificates of deposit;
adding one or more seasoned credit card accounts; and
establishing one or more open accounts of trade credit from one or more suppliers; and
establishing seasoned credit card account(s) in which primary credit card holder(s) add the one or more personal guarantor(s) to one or more of the primary card holder(s)' existing credit card accounts that have been open and in good standing for a sufficient period of time to allow for said credit card accounts to appear on the one or more personal guarantor(s) credit report.

13. The method of claim 1, further comprising a method of credit repair, including the following steps in any order:
disputing any derogatory items on the personal guarantors' credit report with a credit scoring agency;
disputing any credit inquiries on the personal guarantors' credit report with a credit scoring agency until said inquiries are removed;
disputing all inquiries made by lenders to the credit scoring companies on the personal guarantor's credit report directly associated with business credit line applications until said inquiries are removed;
disputing account(s) statuses that are listed as “open” when they are in fact “closed”; and
disputing account(s) that are not the personal guarantor(s)' responsibility.

14. A method of establishing one or more high credit line credit accounts of one or more business entities, comprising the following steps in any order:
entering the high credit line of one or more vendors into a credit account management tool; wherein said high credit line of one or more vendors includes an open trade account of $10,000 or higher that are maintained in good standing; and
reporting said trade accounts(s) to the business credit scoring agencies.

15. The method of claim 11, further comprising the following steps in any order:
increasing the approved dollar amount of the credit limit of said one or more unsecured business lines; and
increasing the credit score of one or more personal guarantors by providing one or more high credit accounts.

16. The method of claim 13, further comprising a method of increasing the credit scores of the one or more personal guarantors, including the following steps in any order:
performing a credit repair process wherein said process includes one or more disputed items;
disputing any derogatory items on the personal guarantors' credit report with a credit scoring agency;
disputing any credit inquiries on the personal guarantors' credit report with a credit scoring agency;
adding one or more new unsecured credit accounts; and
paying down one or more of the one or more personal guarantor's credit card balances.

17. The method of claim 16, further comprising the following steps in any order:
borrowing money from funds deposited;
borrowing money from funds invested in one or more certificates of deposit;
adding one or more seasoned credit card accounts;
establishing one or more open accounts of trade credit from one or more suppliers; and
wherein increasing the credit limit of said one or more personal guarantor's credit line to the maximum allowable amount maximizes the positive impact on the one or more personal guarantor(s)' personal credit score
and wherein said maximum allowable amount maximizes the number of high credit line of credit accounts available to an applicant.

18. The method of claim 14, further comprising a method of establishing one or more high credit line credit accounts of one or more business entities, including:
entering the high credit line credit account management tool;
selecting one or more personal guarantors (PG) to associate with the attainment of said high credit line of credit account management;
verifying said one or more PG's credit rating is sufficient to attain said high credit line credit accounts;
identifying any derogatory credit items on the one or more personal guarantors' credit report;
disputing said derogatory credit items on the one or more personal guarantors' credit report;
identifying and disputing any unauthorized credit inquiries on the one or more personal guarantors' credit report;
paying one or more credit card balances to zero on the one or more personal guarantors' credit report;
increasing a maximum credit limit amount of the one or more personal guarantor(s)' revolving credit line accounts;
borrowing said maximum credit limit amount of the one or more personal guarantor(s)' revolving credit line accounts;
paying off one or more said maximum credit limit amounts of the one or more personal guarantor(s)' revolving credit line accounts to zero on the one or more personal guarantors' credit report;
verifying said payoff;
verifying the credit score at credit bureaus of said one or more business entities; and
obtaining a subsequent increased credit limit amount of the one or more business entities existing business credit line account(s).

19. A method for increasing a credit applicant's aggregate established business credit limits comprising at least one of the following steps in any order:
selecting a non-personally guaranteed cash credit line;
selecting a cash credit without a personal guarantor;
selecting a non-guaranteed credit line
selecting a personally-guaranteed cash credit line of guaranteed and non-guaranteed cash credit lines;
borrowing to the limit of the credit lines established;
paying back credit lines with interest;
waiting a period of time to request credit limit increases for all established business credit lines; and
obtaining an increase of said credit applicant's aggregate established business credit lines' credit limits.
